(19) United States
(12) Patent Application Publication
(10) Pub. No.: US 2024/0370522 A1
(43) Pub. Date: Nov. 7, 2024

(54) METHODS AND SYSTEMS OF DEPTH-WISE SEPARABLE (DWD) CONVOLUTION ON A MULTI-DIMENSIONAL MEMORY FABRIC

(71) Applicant: Cerebras Systems Inc., Sunnyvale, CA (US)

(72) Inventors: Vladimir V. Kibardin, Palo Alto, CA (US); Michael Edwin James, San Carlos, CA (US)

(73) Assignee: Cerebras Systems Inc., Sunnyvale, CA (US)

(21) Appl. No.: 18/141,991

(22) Filed: May 1, 2023

(51) Int. Cl. G06F 17/15; G06F 7/544; G06N 3/0464

(52) U.S. Cl. CPC G06F 17/153; G06F 7/5443; G06N 3/0464

(57) ABSTRACT

Embodiments of the present disclosure are directed to methods and systems for computing depth-wise convolutions on a two-dimensional array (or grid) of compute cores. In a first aspect of the disclosure, a method for running the depth-wise convolution on a two-dimensional array of compute cores comprises of (a) partitioning the input image among the compute cores, such that the compute core array collectively stores the whole image (b) allocating a memory buffer (an accumulator) that holds the subimage plus some frame (or padding) around the subimage (c) receiving convolution filter weights, multiplying the input subimage by the weight and adding to the accumulator with an offset (d) exchanging the information from the subimage frame with the neighboring compute cores. The advantage of the method is that the depth-wise convolution operation can be parallelized across a two-dimensional array of compute cores. In other words, this method enables acceleration of the depth-wise convolution operation (and therefore acceleration of the neural network operation). The depth-wise convolution method comprises (a) receiving the weights of the convolution filter (b) accumulator aliasing, i.e. writing into the same accumulator memory with an offset (c) exchanging small amounts of information with the neighbors.

This invention was made with government support under Contract No. FA864921 P0829 awarded by Department of the Air Force, Department of Defense. The government has certain rights in the invention.

### BACKGROUND

### Technical Field

The present disclosure generally relates to artificial intelligence (AI) software and chips, more particularly to an array of compute cores for computing depth-wise convolution of information including images.

### Background Art

Neural networks are ubiquitous in the areas of artificial and machine intelligence, such as computer vision. One instance of a computer vision task that uses neural networks is image classification, i.e. producing a description or a class information about a given image. For example, the image classifier neural network can indicate that the image portrays a plane or a dog. Another instance of a computer vision task is object recognition or object detection. In this task, the neural network annotates a given image with objects' locations and description. For example, the image detector neural network can draw a rectangle (bounding box) around a building in a photograph and label the building a “house”.

Neural networks are typically run on computer systems. These systems include CPUs, GPUs and other specialized computer equipment sometimes called accelerators. One instance of such accelerators is a Wafer-Scale Engine (WSE), a single chip 192 (or a single wafer) that includes a two-dimensional array of compute cores, available from Cerebras Systems Inc. of Sunnyvale, Calif. In this two dimensional array, each core can contain memory and processing logic, as well as means of communication with the neighboring compute cores.

One of the major operations of neural networks employed in the field of computer vision is a convolution operation. One of the commonly used convolution types is a so-called depth-wise convolution. Given an input image of dimensions W (image width), H (image height) and C (channel count), the depth-wise convolution is described by the following mathematical expression:

$${Y}_{ijc} = {\sum }_{r = 0}^{R} {\sum }_{s = 0}^{S} {X}_{i - rj - sc} * {W}_{rsc}$$

where X_{ijc} is the value of the pixel at coordinates (i,j) on channel c of the input image, Y_{ijc} is the value of the pixel at coordinates (i,j) on channel c of the output (resulting) image, W_{r s c} is value of the convolution filter at position (r,s) on channel c. To produce the output (resulting) image, the convolution expression is evaluated for all output pixels (i,j).

A variant of the depth-wise convolution is so called stride two depth-wise separable convolution. In this variant, the convolution expression is evaluated only for some of the output pixels (i,j), e.g. all odd rows and all odd columns of the output image.

These convolution operations are used by a large variety of computervision neural networks, including MobileNet, MobileDet and HRNet network families.

Accordingly, it is desirable to have methodologies and systems for how certain elements of the neural networks are being implemented (or run) on an accelerator that has a two-dimensional compute core array architecture, such as mapping one or more input images onto an array of processing elements on a wafer scale engine.

### SUMMARY OF THE DISCLOSURE

Embodiments of the present disclosure are directed to methods and systems for computing depth-wise convolutions on a two-dimensional array (or grid) of compute cores. In a first embodiment of the disclosure, a method for running the depth-wise convolution on a two-dimensional array of compute cores comprises of (a) partitioning the input image among the compute cores, such that the compute core array collectively stores the whole image (b) allocating a memory buffer (an accumulator) that holds the subimage plus some frame (or padding) around the subimage (c) receiving convolution filter weights, multiplying the input subimage by the weight and adding to the accumulator with an offset (d) exchanging the information from the subimage frame with the neighboring compute cores. The advantage of the method is that the depth-wise convolution operation can be parallelized across a two-dimensional array of compute cores. In other words, this method enables acceleration of the depth-wise convolution operation (and therefore acceleration of the neural network operation). The novelty of the depth-wise convolution method comprises (a) receiving the weights of the convolution filter (b) accumulator aliasing, i.e. writing into the same accumulator memory with an offset (c) exchanging small amounts of information with the neighbors.

In a second embodiment of the disclosure, a method for running the depth-wise stride two convolution on a two-dimensional array of compute cores comprises of (a) partitioning the input image among the compute cores, such that the compute core array collectively stores the whole image (b) pre-processing (or transforming) the weights of the convolution filter as well as the input image, (c) allocating a memory buffer (an accumulator) that holds the subimage plus some frame (or padding) around the subimage (d) receiving convolution filter weights, multiplying the input subimage by the weight and adding to the accumulator with an offset (e) exchanging the information from the subimage frame with the neighboring compute cores. The advantages of the method for running the depth-wise stride two convolution are similar to the advantages of the method for running the depth-wise convolution, including the parallelization of the operation workload across a two-dimensional array of cores. Another advantage is a possible re-use of some of the depth-wise convolution method steps, that facilitates faster development. The depth-wise stride two convolution method comprises (a) the pre-processing (or transformation) steps for the input subimages as well as the convolution filter weights, (b) receiving the weights of the convolution filter (c) accumulator aliasing, i.e. writing into the same accumulator memory with an offset (d) exchanging small amounts of information with the neighbors.

In a third embodiment of the disclosure, the system enabling the methods for running the depth-wise convolutions comprises (a) a source (or storage) for convolution filter weights (b) a source (or storage) for the commands that direct the execution of the neural network on a two-dimensional array of cores (c) modules for broadcasting and distributing the weights and commands to the two-dimensional array of compute cores and (d) the processing modules comprising sub-arrays of the two-dimensional array of compute cores. The advantages of the system comprises (a) the separation of the weights and commands storage from the modules that perform the convolution operations, allowing a fine-grain control of the operation as well as overcoming the storage limitations of the two-dimensional array of compute cores and (b) the flexibility to choose the configuration of processing modules, which can be used to maximize the acceleration. The novelty of the system comprises (a) keeping (or storing) the weights separate from the processing modules and streaming the weights as needed (b) partitioning the two-dimensional array of compute cores into a number of sub-arrays and (c) the distribute and broadcast modules facilitating the connection between the processing modules and the weight/command modules.

In a fourth embodiment of the disclosure, the method to change (or transform) the layout of the processing modules comprises (a) compute cores sending the subimages to a designated compute core (b) the designated compute core broadcasting the received subimages to the rest of the compute cores (c) compute cores using a data filter to accept the portion of the subimages that is consistent with the new (transformed) layout. The advantages of the method comprises (a) the ability to change the configuration of the processing modules (i.e. quantity and size) during the course of the neural network execution, allowing to maximize the acceleration (b) the ability to overlap the layout change (or transformation) with other operation, therefore minimizing the computation overhead. The novelty of the method comprises the use of the data filter in concert with the broadcast operation.

In another embodiment, the depth-wise convolution system is sparsified, which can be highly data intensive and less computational intensive. For example, in a conventional system, when a depth-wise convolution operation is data intensive, that depth-wise convolution operation tends not be computational intensive. This approach stresses on a memory load subsystem rather than the computational arithmetic. When a depth-wise convolution operation is data intensive, a conventional system may encounter challenges to load the data into a processor, which means that the processor is idle at times; the processor is not actually performing a computation but waiting for data to arrive (or to be loaded). One unique feature of the depth-wise convolution system of the present disclosure is that data is pre-distributed (or predistributed, or distributed in advance) over a two-dimensional (2D) array of compute cores, such that the data lives (or resides, or loaded, or placed) right there on the compute cores; the data is therefore already loaded (or preloaded) in advance across applicable compute cores and ready for computation by each compute core. All of this novel mapping and alignment from image data (software), e.g., a very large image, to the array of compute cores (hardware) is a mechanism for efficiently executing the depth-wise convolution. A conventional system would encounter bottlenecks waiting for the data to arrive. The depth-wise convolution system in this embodiment is designed to perform all of the data movements, resulting in the improvement of overall computational performance. Advantageously, the depth-wise convolution system keeps the compute cores active (not idling) in actually performing useful computations, rather than waiting for data to arrive, because the data is partitioned (or meshed over an array of compute cores) and distributed over the two-dimensional array of compute cores.

In a further embodiment, the depth-wise convolution system is designed with an array of cores and manufactured on a single wafer for fast processing of a very large image, both data efficiently and computational efficiently, which the data image, for example, has a size of 32 k by 32 k, with approximately 1 billion pixels. Such large scale of image is difficult for a conventional system to process because the conventional system could not load the data fast enough into different computing elements, which produces poor computing performance. In the present disclosure, not only is the data preloaded onto the array of compute cores, the data stays (or kept) resident on the array of compute cores over the duration of the depth-wise convolution operation. Each compute core has a local memory for storing data (for example, a portion of the image data, convolution filter weight) and an arithmetic logical unit (ALU), and one or more very high bandwidth connections with other compute cores. So long as the depth-wise convolution system maps and distributes a large image data in such a way as not to cause communication challenges between the compute cores, then the resulting performance of the depth-wise convolution system would meet the dual objectives in both data efficiency and computational efficiency. The depth-wise convolution system continues to work on the array of compute cores for processing the image data as the neural network is evaluated layer by layer. Advantageously, the depth-wise convolution system of this embodiment has the dual capabilities, both fast image data processing and fast computing with the array of compute cores.

Broadly stated, a method for M×N single channel depth-wise convolution, on a two-dimensional array of compute cores comprises (a) partitioning the input image to a plurality of subimages, each subimage having dimensions of Δw (subimage width)×Δh (subimage height), each subimage residing on the at least one compute core; (b) allocating a portion of a memory in the at least one compute core with the dimensions of (Δw+w_{f})×(Δh+h_{f}) to serve as an accumulator, where w_{f} and h_{f} are dimension of the extra space (frame) around the subimage; (c) set the accumulator with an offset (i, j); (d) receiving one or more weights by the plurality of compute cores; (e) updating the accumulator by multiplying the input image by a weight Wᵢⱼ and adding the result to the accumulator with an offset of (i, j); and (f) repeating steps (c)-(e) for all N×M (i,j) offset combinations: i ranging from 0 to N−1 and j ranging from 0 to M−1; and (g) sending, by at least one compute core, a portion of the accumulator to the one or more neighboring compute cores; (h) updating the accumulator of the at least one compute core with information received from the one or more neighboring compute cores, wherein the result of the above steps is in the accumulator.

The structures and methods of the present disclosure are disclosed in detail in the description below. This summary does not purport to define the disclosure. The disclosure is defined by the claims if any. These and other embodiments, features, aspects, and advantages of the disclosure will become better understood with regard to the following description, appended claims, and accompanying drawings.

### BRIEF DESCRIPTION OF THE DRAWINGS

The disclosure will be described with respect to specific embodiments thereof, and reference will be made to the drawings, in which:

FIG. 1A is a block diagram illustrating a high-level description of the software engine with a plurality of modules for performing the neural network inference operations in accordance with the present disclosure; and FIG. 1B is system communication diagram illustrating the flow of information between a computer server and a wafer-scale engine (WSE) for processing multiple layers with commands and weights in accordance with the present disclosure.

FIG. 2 is a flow chart illustrating an example of an algorithm with the depth-wise N×M convolution (here for example as 3×3 convolution) applied to an input image of dimensions W (image width)×H (image height)×C (image channel count) in accordance with the present disclosure.

FIG. 3 depicts two samples of step 300 with the dimensions of the subimage S are four rows by five columns in accordance with the present disclosure.

FIG. 4 is a block diagram illustrating a row frame exchange process in accordance with the present disclosure.

FIG. 5 is a block diagram illustrating a column frame exchange process in accordance with the present disclosure.

FIG. 6 is a flow chart illustrating an example of an algorithm with the depth-wise N×M stride-2 convolution as applied to an input image of dimensions with an image width, an image height, and an image channel count in accordance with the present disclosure.

FIG. 7 is a block diagram illustrating an example of the stride-2 subimage transformation in accordance with the present disclosure.

FIG. 8 is a block diagram illustrating the conclusion (at step 238) of the depth-wise 3×3 convolution the conclusion of the stride-2 depth-wise 3×3 convolution at step in accordance with the present disclosure.

FIG. 9 is a block diagram illustrating one example of the mapping layout change in accordance with the present disclosure.

FIG. 10 is a block diagram illustrating an example of the layout change implementation where all columns of the two dimensional core array act independently of each other in accordance with the present disclosure.

FIG. 11 is a block diagram illustrating that each compute core selects the relevant portion of the data using a window filter in accordance with the present disclosure.

FIG. 12 is a block diagram illustrating an example of the layout transform operation that is overlapped with a gather operation in accordance with the present disclosure.

FIG. 13 is an overall diagram the drive subsystem partitioning an input image data for the neural network inference operations and distribution of a plurality of subimages across an array of compute cores in the wafer scale engine 190 with respect to FIGS. 1A and 1B by processing multiple layers with commands and weights operation in accordance with the present disclosure.

FIG. 14 is a block diagram illustrating an example of a computer device on which computer-executable instructions to perform the methodologies discussed herein may be installed and run in accordance with the present disclosure.

### DETAILED DESCRIPTION

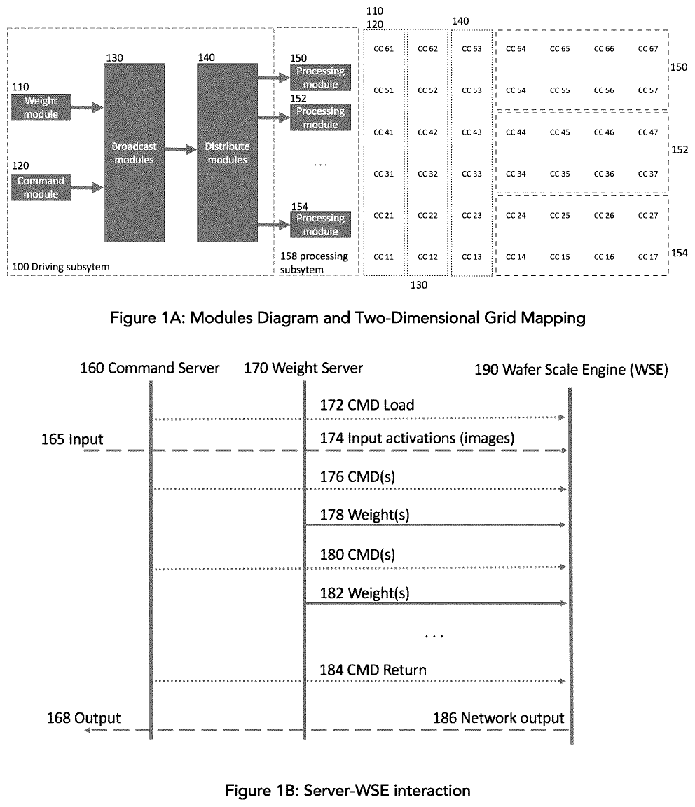

A description of structural embodiments and methods of the present disclosure is provided with reference to FIGS. 1-14. It is to be understood that there is no intention to limit the disclosure to the specifically disclosed embodiments, but that the disclosure may be practiced using other features, elements, methods, and embodiments. Like elements in various embodiments are commonly referred to with like reference numerals.

FIG. 1A illustrates on the left-side view that provides a high-level description of the software engine performing the neural network inference operations. Weight module 110 stores and sends the weights of the neural network layers' (e.g. convolution) filters through one or more broadcast modules 130 and one or more distribute modules 140 to one or more processing modules 150. The weight module 110 can also pre-process (or pre-transform) some of the weights (e.g. as in stride-2 weight transform 710, 720) Command module 120 stores and sends the commands (or instructions) that drive the execution of the neural network through one or more broadcast modules 130 and one or more distribute modules 140 to one or more processing modules 150. Jointly, the weight module 110 and the command module 120 contain the information needed to drive (or execute) the neural network operation.

One or more broadcast modules 130 receives the commands (instructions) and weights from the respective modules (110 and 120) and broadcasts the common portion of command (instruction) and weights to one or more processing elements 150. In other words, if a command (instruction) should be sent to more than one processing module (or parts of a processing module), the broadcast module sends the command multiple times to the correct destinations.

One or more distribute module 140 receives the weights and commands (instructions) from either the command/weight modules (110 and 120) or from one or more broadcast modules 140 and distributes these across one or more processing modules 150 or individual computational cores (also referred to as “compute cores” or “computer cores”) of one or more processing modules 150. In other words, the distribute module receives a (single) stream of commands (instructions) and distributes the stream across multiple destinations (e.g. multiple processing modules or multiple parts of a processing module)

FIG. 1A illustrates on the right-side view a possible mapping of the software engine onto a two-dimensional array of compute cores. The term mapping describes for each compute core which of one or more modules the compute core runs. To phrase it another way, there is a correlation between the software modules on the left side of FIG. 1A to the hardware elements (compute cores) on the right side of FIG. 1A.

In this example for illustration purposes, the compute core array comprises six rows and seven columns, with a total of 42 compute cores. The command module 110 and the weight module 120 are mapped to (or associated with) the first column of compute cores (CC11-CC61). In other words, the plurality of compute cores in the first column of the two-dimensional array (CC11-CC61) collectively runs the command module 110 and weight module 120. The broadcast module 130 is mapped to (or associated with) the second column of compute cores (CC12-CC62). In other words, the plurality of compute cores in the second column (CC12-CC62) runs the broadcast module 130. The distribute module is mapped to (or associated with) the third column of compute cores (CC13-CC63). In other words, the plurality of compute cores (CC13-CC63) in the third column runs the distribute module 140.

Finally, a processing subsystem 158 includes a plurality of processing modules 150, 152, 154. The plurality of the processing modules (in this particular example 150, 152, 154) is mapped to (or associated with) the remaining columns (CC14-CC64, CC15-CC65, CC16-CC66, CC17-CC67) of compute cores. The first processing module 150 is mapped to (or associated with) the compute cores CC14, CC15, CC16, CC17, CC24, CC25, CC26, CC27. The second processing module 152 is mapped to (or associated with) the compute cores CC34, CC35, CC36, CC37, CC44, CC45, CC46, CC47. The third processing module 154 is mapped to (or associated with) the compute cores CC54, CC55, CC56, CC57, CC64, CC65, CC66, CC67. In other words, each of the three rectangular sub-arrays collectively run one of the three processing modules 150, 152 and 154. The driving subsystem 100 and the processing subsystem 158 together form a system for running a neural network operations (such as depth-wise convolution).

The term “array” as used in the present disclosure means an array comprising one or more compute cores.

Typically, processing modules process (or transform) portions of the input tensor (or images) that are independent of each other. For example, each processing module can process a full image, but a portion of the channels. In a different example, an input image contains 3 channels (red, green and blue), each processing module 150, 152, 154 can process each input channel independently. In other words, the processing module 150 can process the red channel of the input image, the processing module 152 can process the green channel of the input image and the processing module 154 can process the blue channel of the input image.

The locations, sizes and quantities of the modules aren't fixed and can change during the course of the neural network inference process. The engine modules' parameters define the performance of the whole neural network (e.g. more cores in the processing modules may make the process faster). Sometimes, the engine parameters are constrained by the operation the engine is running or the input/output tensors it is using. In the previous example of three channels, at most 3 processing modules can be used.

Finally, not all of the engine's components are required to be run on the two-dimensional array of compute cores. For example, the command module 110 and the weight module 120 can be run on the separate computer servers (e.g. 160 and 170 in FIG. 1B).

FIG. 1B is a communication diagram illustrating the flow of information between subsystems (of a driving subsystem 100). The driving subsystem 100 comprises a command server 160, a weight server 170 and wafer scale engine (WSE) 140. The command server 160 sends one or more commands to the wafer scale engine 140 in driving the execution of the neural network. The commands include, but not limited to: load image (CMD Load 122), return results (CMD return 134), perform parts of the convolutions or other neural network layers. The weight server 170 sends numeric data, like matrices, tensors, or convolution filters to the wafer scale engine 140.

A typical flow for a neural network inference is shown in FIG. 1b. First, the command server 160 sends an initial “CMD Load 172” to the wafer scale engine 190. In response to the command, the wafer scale engine 190 is ready to accept an image (or an image data, or an image object), which is supplied as an input 165 to the network. During the load procedure, each compute core in the array gets a portion of the input image. In this way, the input image is partitioned into a plurality of subimages and the plurality of subimages are distributed across the array of compute cores. Next, the servers 160 and 170 instruct the wafer scale engine 190 to execute the neural network by issuing a sequence (or a plurality) of network specific commands 174-182 (e.g. parts of convolution or a matrix multiply) interleaved with the weights for one or more specific layers. During the execution of the neural network, the input image (or the image data) to the next neutral network layer is the output image of the previous neural network layer. In this way of the embodiment, the input image to each neural network layer (including but not limited to depth-wise convolution) is distributed (or partitioned, or filtered) across the two-dimensional array of compute cores. In other words, each neural network layer (e.g. a depth-wise convolution) works with an input image distributed across the two-dimensional array of compute cores. Finally, the command server 160 sends a “CMD return” 184 command. In response to the command 184, the wafer scale engine 190 sends the resulting data 186 to the output 168. The flow information in the system 100 represents one example. Other variations and modifications can be made to the flow information without departing from the spirits of the present disclosure.

The input 165 and the output 168 of the system 100 could be connected to the client side of the system (e.g., sending a surveillance camera feed and receiving objects' locations and classes back).

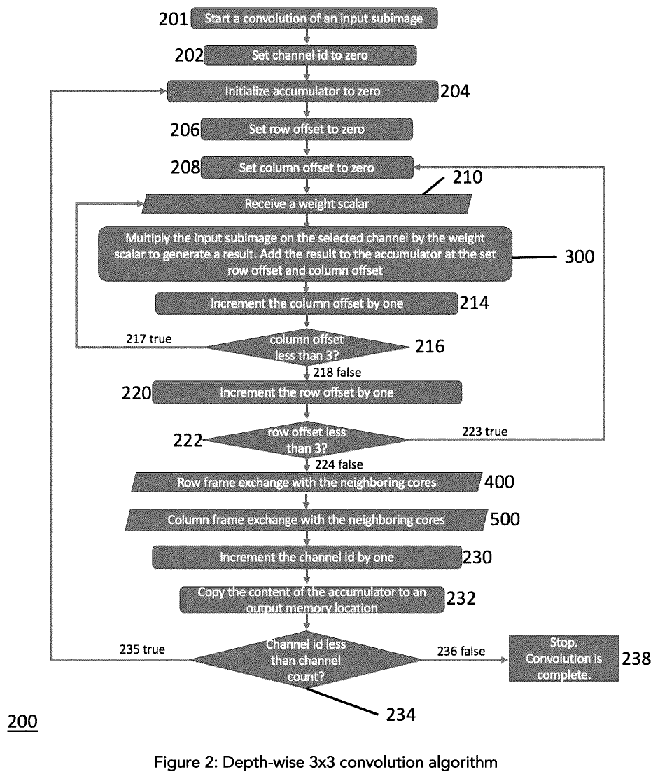

FIG. 2 is a flow chart illustrating an example of an algorithm 200 with the depth-wise N×M convolution (here as 3×3 convolution) applied to an input image of dimensions W (image width)×H (image height)×C (image channel count). It is also represented mathematically as W×H×C, or in words as dimension W by dimension H by dimension C. In one embodiment, each compute core participating in the convolution is executing the algorithm 200 specified in FIG. 2. In other words, all the steps (or actions) in the algorithm 200 run on each individual compute core.

At the beginning of the convolution at step 201, each compute core has a sub-input image S of dimension Δw (subimage width)×Δh (subimage height)×Δc (subimage channel count), while the plurality of the cores running the convolution collectively contain the full input image. The subimage residing on each compute core is a result of partitioning of the input image or the image data (either loaded from outside of the wafer-scale engine or resulting from computing the previous neural network layer). The input subimage is loaded from one of the sources, such as the input 150 of the system 100, or the input subimage could be present in the compute core's memory as a result of a previous operation (e.g., another convolution).

In the beginning of the convolution algorithm, at step 202, the core initializes the channel id c to zero. At step 204, an accumulator A as an array having dimensions of (Δw+2)×(Δh+2) is initialized to zero, where Δw and Δh are the width and the height of the input subimage respectively. At steps 206 and 208 respectively, a row offset i₀ and a column offset j₀ are initialized to zero.

At step 210, the compute core receives a weight scalar (a single number) W from the weight server 170. At step 300, as executed by the compute core, the input subimage S multiplied by the received weight W is added to the accumulator A at the row offset i₀ and a column offset j₀:

$${A}_{i + i 0 j + j 0} = {A}_{i + i 0 j + j 0} + {S}_{cij} * w \qquad Eq ( 1 )$$

$$0 < i < Δ w , 0 < j < Δ h$$

where the symbol Aᵢⱼ represents the value of the accumulator at row i and column j, and the symbol S_{cij} represents the value of the input subimage at channel c, row i and column j. The inequalities 0<i<Δw, 0<j<Δh mean that the equation Eq(1) is applied to all elements of the subimage S. In this way, one or more arithmetic operations of the depth-wise convolution are distributed across the two-dimensional array of compute cores, resulting in computational efficiency because the one or more arithmetic operations are divided and distributed for computation by several compute cores simultaneously. In other words, the plurality of compute cores collectively perform the arithmetic operation of the depth-wise convolution, while each compute core performs a portion of the arithmetic operations.

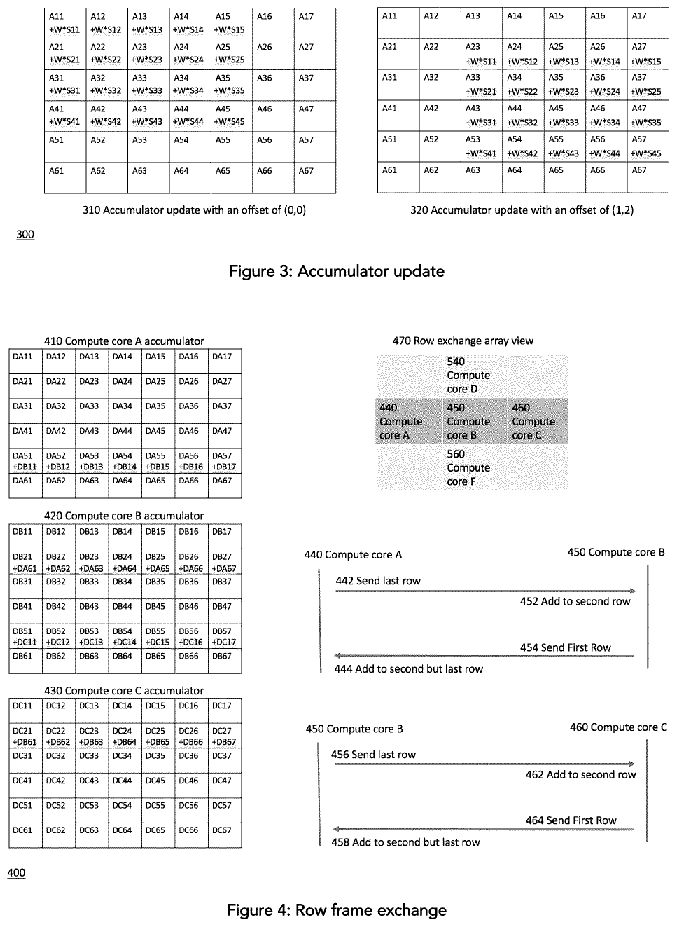

FIG. 3 depicts two possible instances of step 300. In this particular example for illustration purposes, we are using concrete (or specific) values of Δw=5 and Δh=4. In other words, the dimensions of the subimage S are 4 rows by 5 columns. The dimensions of the accumulator are therefore 6 (i.e. Δh+2) rows and 7 (i.e. Δw+2) columns.

Example 310 shows the application of Eq(1) in a case of zero column offset and zero row offset (i₀=0 j₀=0). A subimage S pixel at row and column (1,1) is multiplied by the received weight W and the resulting product is added to the contents of accumulator A at row 1 and column 1. In otherwords, the data contents of location A₁₁ is replaced with updated data contents of (or transformed into) A₁₁+W*S₁₁, where A₁₁ is the accumulator value at row 1 column 1 and S₁₁ is the subimage value at row 1 column 1. The compute core applies the same operation to all other pixels of the subimage S: Aᵢⱼ=Aᵢⱼ+W*Sᵢⱼ, where Aᵢⱼ is data content of the accumulator at row i and column j, and Sᵢⱼ is a pixel value of the subimage S at row i and column j. In this way, one or more the arithmetic operations of the depth-wise convolution are distributed across the two-dimensional array of compute cores, resulting in computational efficiency because the one or more arithmetic operations are divided and distributed for computation by several compute cores simultaneously. In other words, the plurality of compute cores collectively perform the arithmetic operation of the depth-wise convolution, while each compute core performs a portion of the arithmetic operations.

Sample 320 shows the application of eq(1) in a case of a row offset of 1(i₀=1) and column offset of 2 (j₀=2). A subimage S pixel at row 1 and column 1 (S₁₁) is multiplied by the received weight W and the resulting product is added to the accumulator value at row 2 (1+i₀) and column 3 (1+j₀). In otherwords, the data contents of location A₂₃ is replaced with updated data contents of (or transformed into) A₂₃+W*S₁₁, where A₂₃ is the accumulator value at row 2 column 3 and S₁₁ is the subimage value at row 1 column 1. The compute core applies the same operation to all other pixels of the subimage S: Aᵢ₊₀₊ⱼ₀=A_{i+i0 j+j0}+W*Sᵢⱼ where A_{i+i0 j+j0} is data content of the accumulator at row i+i0 and column j+j0, and Sᵢⱼ is a pixel value of the subimage S at row i and column j.

After step 300 is complete and all pixels of the subimage S are multiplied by W and the resulting product is added to the respective accumulator positions, the compute core increments the column offset j₀ by 1 in step 214 (See FIG. 2). Then at step 216, the compute core compares the column offset j₀ to 3 (given the 3×3 convolution). If the column offset j₀ is less than 3, the compute core returns to step 210. Otherwise, the compute core executes step 220 incrementing the row offset i₀ by 1. Next, the compute core compares the row offset i₀ to 3 in step 222. If the row offset i₀ is less than 3, the compute core returns to step 208. Otherwise, the compute core proceeds to the frame exchanges.

In other words, the portion of the algorithm that starts at step 206 and ends at step 222, makes the compute core apply the Eq(1) for row offsets 0, 1 and 2 (0<i₀<3) and column offsets 0, 1 and 2 (0<j₀<3).

At step 400, the compute core executes the row frame exchange. An example of the row exchange for an 6×7 (6 rows and 7 columns) subimage is illustrated in FIG. 4. In the row frame exchange, a compute core B (450) exchanges information with an immediate left neighbor A (440) and an immediate right neighbor C (460), with the exception of the edge compute cores. Left-most compute cores (compute cores on the left edge of the array) are only exchanging information with right neighbors (because left-most compute cores have no left neighbors). Right-most compute cores (compute cores on the right edge of the two-dimensional array) are only exchanging information with left neighbors (because right-most compute cores have no right neighbors).

The row frame exchange 400 comprises four operations that can be executed independently of each other, in any order, or in parallel. In this way, the data exchange between the compute cores is distributed across the two-dimensional array of compute cores, similarly to the distribution of the arithmetic operations. FIG. 4 depicts one possible ordering of the row frame exchange operations.

First two operations comprise the exchange between compute core A (440) and compute core B (450) (a compute core and a left neighboring compute core). At step 442, the compute core A (440) sends the contents of the accumulator's 410 last row (DA61, DA62, . . . DA67) to the neighboring compute core B (450). At step 452, the compute core B (450) receives the last row (DA61-DA67) of accumulator 410 and adds the received values to the data contents of the accumulator's 420 second row. The resulting sums replace the data contents of the accumulator's 420 second row (DB22-DB27). In other words, the one or more data contents in the second row of the accumulator 420 is/are replaced with one or more data contents of (or transformed into) DB21+DA61, DB22+DA62, . . . , DB27+DA27. In this way, the addition operation (or arithmetic operation) is happening in parallel (or at the same time or concurrently) with the data exchange between the compute cores. In other words, the arithmetic operations overlap in time with the data exchange operation.

At step 454, the compute core B (450) sends the data contents of the accumulator's 420 first row (DB11-DB17) to the neighboring compute core A (440). At step 444, the compute core A (440) receives the first row (DB11-DB17) and adds the received values to the data contents of the accumulator's 410 second but last row (DA51-DA57). The resulting sums replace the data contents of the accumulator's 410 second but last row. In other words, the one or more data contents in the second but last row of the accumulator 410 is/are replaced with one or more data contents of (or transformed into) DA51+DB11, DA52+DB12, . . . , DA57+DB17. In this way, the addition operation (or arithmetic operation) is happening in parallel (or at the same time or concurrently) with the data exchange between the compute cores. In other words, the arithmetic operations overlap in time with the data exchange operation.

The second two operations comprise the exchange between compute core B (450) and compute core C (460) (a compute core and a right neighboring compute core). At step 456, the compute core B (450) sends the contents of the accumulator's 420 last row (DB61, DB62, . . . DB67) to the neighboring compute core C (460). At step 462, the compute core C (460) receives the last row (DB61-DB67) of accumulator 420 and adds the received values to the data contents of the accumulator's 430 second row. The resulting sums replace the data contents of the accumulator's 430 second row (DC22-DC27). In other words, the one or more data contents in the second row of the accumulator 430 is/are replaced with one or more data contents of (or transformed into) DC21+DB61, DC22+DB62, . . . , DC27+DB27. In this way, the addition operation (or arithmetic operation) is happening in parallel (or at the same time or concurrently) with the data exchange between the compute cores. In other words, the arithmetic operations overlap in time with the data exchange operation.

At step 464, the compute core C (460) sends the data contents of the accumulator's 430 first row (DC11-DC17) to the neighboring compute core B (450). At step 458, the compute core B (450) receives the first row (DC11-DC17) and adds the received values to the data contents of the accumulator's 420 second but last row (DB51-DB57). The resulting sums replace the data contents of the accumulator's 420 second but last row. In other words, the one or more data contents in the second but last row of the accumulator 420 is/are replaced with one or more data contents of (or transformed into) DB51+DC11, DB52+DC12, . . . , DB57+DC17. In this way, the addition operation (or arithmetic operation) is happening in parallel (or at the same time or concurrently) with the data exchange between the compute cores. In other words, the arithmetic operations overlap in time with the data exchange operation.

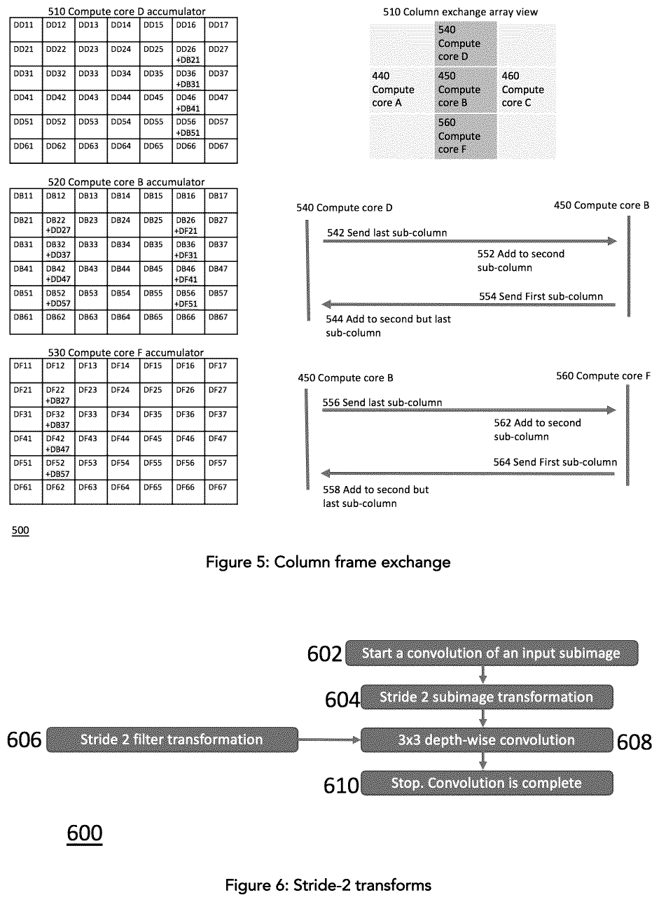

After the compute core completes the row frame exchange, the compute core executes the column frame exchange at step 500 (see FIG. 2). The column frame exchange 500 comprises four operations that can be executed independently of each other, in any order, or in parallel. In this way, the data exchange between the compute cores is distributed across the two-dimensional array of compute cores, similarly to the distribution of the arithmetic operations. FIG. 5 depicts one possible ordering of the row frame exchange operations.

First two operations of the column frame exchange comprise the exchange between compute core D (540) and compute core B (450) (a compute core and a top neighboring compute core). At step 542, the compute core D (540) sends the contents of the accumulator's 510 last sub-column to the neighboring compute core B (450). The term “sub-column” means a column without the first element and the last element for that particular column. The last sub-column of the accumulator 510 comprises elements DD27, DD37, . . . DD57. At step 552, the compute core B (450) receives the last sub-column (DD27-DD57) of accumulator 510 and adds the received values to the data contents of the accumulator's 420 second sub-column (DB22-DB52). The resulting sums replace the data contents of the accumulator's 420 second sub-column (DB22-DB52). In other words, the one or more data contents in the second sub-column of the accumulator 420 is/are replaced with one or more data contents of (or transformed into) DB22+DD27, DB32+DD37, . . . , DB52+DD57. In this way, the addition operation (or arithmetic operation) is happening in parallel (or at the same time or concurrently) with the data exchange between the compute cores. In other words, the arithmetic operations overlap in time with the data exchange operation.

At step 554, the compute core B (450) sends the data contents of the accumulator's 420 first sub-column (DB21-DB51) to the neighboring compute core D (540). At step 544, the compute core D (540) receives the first sub-column (DB21-DB51) and adds the received values to the data contents of the accumulator's 510 second but last sub-column (DD26-DD56). The resulting sums replace the data contents of the accumulator's 510 second but last row. In other words, the one or more data contents in the second but last row of the accumulator 510 is/are replaced with one or more data contents of (or transformed into) DD26+DB21, DD36+DB31, . . . , DD56+DB51. In this way, the addition operation (or arithmetic operation) is happening in parallel (or at the same time or concurrently) with the data exchange between the compute cores. In otherwords, the arithmetic operations overlap in time with the data exchange operation.

Second two operations of the column frame exchange comprise the exchange between compute core F (560) and compute core B (450) (a compute core and a bottom neighboring compute core). At step 556, the compute core B (450) sends the contents of the accumulator's 420 last sub-column, a column without first and last elements (DB27, DB37, . . . DB57) to the neighboring compute core F (560). At step 562, the compute core F (560) receives the last sub-column (DB27-DB57) of accumulator 420 and adds the received values to the data contents of the accumulator's 530 second sub-column (DF22-DF52). The resulting sums replace the data contents of the accumulator's 530 second sub-column (DF22-DF52). In other words, the one or more data contents in the second sub-column of the accumulator 530 is/are replaced with one or more data contents of (or transformed into) DF22+DB27, DF32+DB37, . . . , DF52+DB57. In this way, the addition operation (or arithmetic operation) is happening in parallel (or at the same time or concurrently) with the data exchange between the compute cores. In other words, the arithmetic operations overlap in time with the data exchange operation.

At step 564, the compute core F (560) sends the data contents of the accumulator's 530 first sub-column (DF21-DF51) to the neighboring compute core B (450). At step 558, the compute core B (450) receives the first sub-column (DF21-DF51) and adds the received values to the data contents of the accumulator's 420 second but last sub-column (DB26-DB56). The resulting sums replace the data contents of the accumulator's 420 second but last row. In other words, the one or more data contents in the second but last row of the accumulator 420 is/are replaced with one or more data contents of (or transformed into) DB26+DF21, DB36+DF31, . . . , DB56+DF51, concluding the frame exchange. In this way, the addition operation (or arithmetic operation) is happening in parallel (or at the same time or concurrently) with the data exchange between the compute cores. In other words, the arithmetic operations overlap in time with the data exchange operation.

In other embodiments, the order of frame exchanges can be swapped, for example: first, the compute core executes the column frame exchange, and second, the compute core executes the row frame exchange. In the swapped order case, the column frame exchange deals with one or more full columns and the row frame exchange deals with one or more sub-rows. The term “sub-row” means a row without the first element and the last element for that particular row. One of ordinary skilled in the art would recognize that other variations and modifications to the frame exchanges can be practiced without departing from the spirits of the present disclosure.

After the compute core completes the column frame exchange, the accumulator of the compute core contains the resulting subimage of the convolution operation. The plurality of compute cores collectively contain the resulting image of the convolution operation. At step 230 (see FIG. 1), the compute core increments the channel id (or “channel ID”) by one. At step 232, the compute core copies the accumulator to a memory location designated to store the resulting subimage. At step 234, the compute core compares the channel id to the total channel count. If the channel id is less than channel count, the compute core returns to step 204 (initialize the accumulator to zero). In other words, the compute core repeats the single channel convolution (steps 204-232) for all input channels. If the comparison in step 234 returns false (i.e. the compute core has completed computation for all the input channels), the depth-wise 3×3 convolution of the input image is complete. The resulting output image of the depth-wise convolution is distributed across the two-dimensional array of compute cores, similarly to the input image. In this way, the next neural network layer (e.g. another depth-wise convolution) will already start with having the input image partitioned or distributed across the two-dimensional array of compute cores.

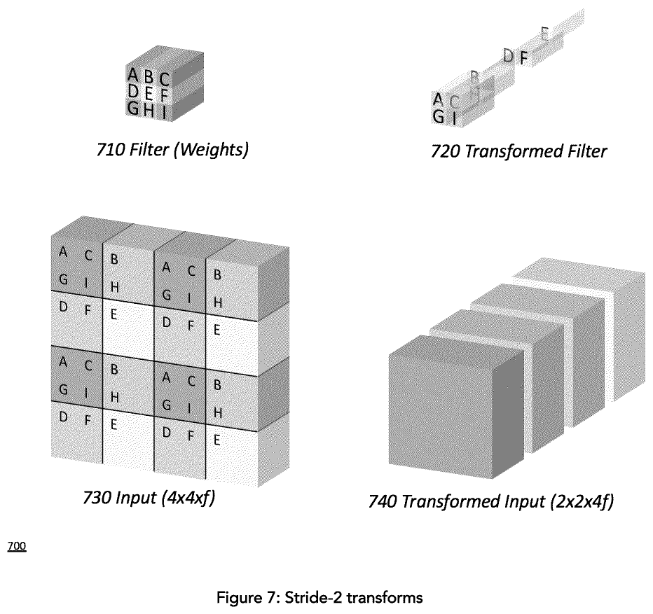

FIG. 6 is a flow chart illustrating an example of an algorithm 600 with the depth-wise N×M stride 2 convolution (as an example here, depth-wise 3×3 stride-2 convolution) applied to an input image of dimensions W (image width)×H (image height)×C (image channel count). It is also represented mathematically as W×H×C, or in words as dimension W by dimension H by dimension C.

At the beginning of the convolution at step 602, each compute core has a sub-input image S of dimension Δw (subimage width)×Δh (subimage height)×Δc (subimage channel count), while the plurality of the cores running the convolution collectively contain the full input image. The input subimage is loaded from one of the sources, such as the input 150 of the system 100, or the input subimage could be present in the compute core's memory as a result of a previous operation (e.g., another convolution).

At step 604, the compute core applies a stride-2 subimage transformation that transforms the input subimage of dimensions Δw×Δh×Δc into a subimage of dimensions Δw/2×Δh/2×4Δc. The transformation itself conserves all the pixels of the input subimage, while changing the order. FIG. 7 Illustrates an example of the stride-2 subimage transformation. In this example, the input subimage 730 is of dimensions 4×4×f and the (resulting) transformed subimage 740 is of dimensions 2×2×4f. The transformed subimage comprises 4 sets of f channels (hence the 4 f in the dimensions).

The first set of f channels of the transformed subimage comprises all odd rows (row 1 and row 3) and all odd columns (column 1 and column 3) of the input subimage (in the example, denoted by letters A, C, G, I in FIG. 7).

The second set of f channels comprises all odd rows (row 1 and row 3) and all even columns (column 2 and column 4) of the input subimage (denoted by letters B and H in FIG. 7).

The third set of f channels comprises all even rows (row 2 and row 4) and all odd columns (column 1 and column 3) of the input subimage (denoted by letters D and F in FIG. 7).

Finally, the fourth set of f channels comprises all even rows (row 2 and row 4) and all even columns (column 2 and column 4) of the input subimage (denoted by letter E in FIG. 7).

At step 606 (see FIG. 6), the compute core applies the stride-2 transformation to the weights of the convolution filter. Step 606 can also be executed by the weight server instead. FIG. 7 illustrates an example of the stride-2 filter transformation. In this example, an input convolution filter 710 has dimensions of 3×3×f and the (resulting) transformed filter has dimensions of 3×3×4f. Similarly to the subimage stride-2 transformation, the transformed filter has 4 sets of f channels (hence the 4 f in the dimensions).

In this example, the first set of f channels comprises all odd rows (row 1 and row 3) and odd columns (column 1 and column 3) of the input filter (denoted by letters A, C, G, I).

The second set of f channels comprises all odd rows (row 1 and row 3) and even columns (column 2) of the input filter (denoted by letters B and H).

The third set of f channels comprise all even rows (row 2) and all odd columns (column 1 and column 3) of the input filter (denoted by letters D and F).

Finally, the fourth set of f channels comprises all even rows (here just row 2) and all even columns (here just column 2) of the input filter (denoted by letter E).

At step 608, the compute core performs the depth-wise 3×3 convolution on the stride-2 transformed input subimage 740 and using the stride-2 transformed convolution filter weights 720. The depth-wise 3×3 convolution can be performed using the algorithm 200.

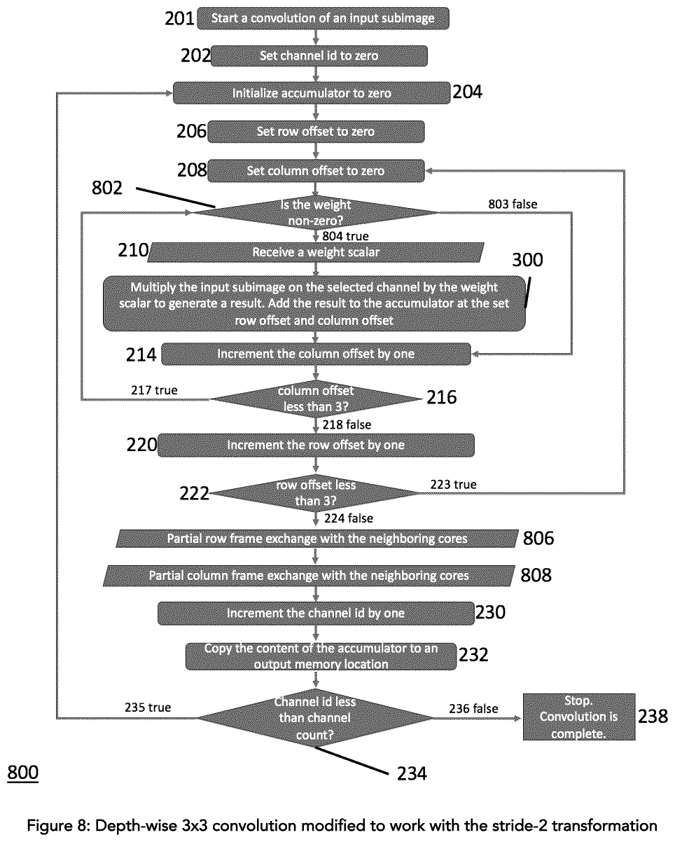

Other ways to perform step 608 include an algorithm 800 illustrated in FIG. 8. The algorithm 800 is an alternate embodiment and modification of algorithm 200. The steps in algorithm 800 that have the same reference numbers as the steps in algorithm 200 would have the same functional meaning. Prior to step 210 in algorithm 800, the compute core checks if the receiving weight scalar is supposed to contain any data or is it just zero. In the check, the compute core computes the current channel set number (c/f). Based on the set number, the compute core evaluates the following expression:
a. if the channel set is 1: evaluate criteria i0<2 and j0<2
b. if the channel set is 2: evaluate criteria i0<2 and j0<1
c. if the channel set is 3: evaluate criteria i0<1 and j0<2
d. if the channel set is 4: evaluate criteria i0<1 and j0<1
   If the resulting value is false (i.e. the evaluated criteria comes negative), the compute core jumps to step 214, omitting step 300. Otherwise, the compute core proceeds to step 210.

The other two modifications to algorithm 200 comprise replacing steps 400 and 500 with steps 806 and 808 respectively, i.e. the row and column frame exchanges are replaced with partial row frame exchange and partial column frame exchange respectively.

In contrast to algorithms 500 and 600, where the whole frame (such as a whole frame identified with two rows and two columns) participates in the frame exchange, in algorithm 806 and algorithm 808 just a portion of the frame (such as one column and/or one row of the frame) participates in the frame exchange. In this embodiment, the partial row frame exchange 806 comprises just the first two operations of the row frame exchange 400: step 442, step 452, step 454, step 444, excluding steps 456, 462, 464, 458 (see FIG. 4). The partial column frame exchange 808 comprises just the first two operations, in this illustration, of the column frame exchange 500: step 542, step 552, step 554, step 544, excluding steps 556, 562, 564, 558 (see FIG. 5).

In some embodiments, the order of partial frame exchanges can be swapped, for example: first, the compute core executes the column partial frame exchange, and second, the compute core executes the row partial frame exchange. In the swapped order case, the column partial frame exchange deals with one or more full columns and the row partial frame exchange deals with one or more sub-rows. The term “sub-row” means a row without the first element and the last element for that particular row. One of ordinary skilled in the art would recognize that other variations and modifications to the frame exchanges can be practiced without departing from the spirits of the present disclosure.

The conclusion (at step 238, FIG. 8) of the depth-wise 3×3 convolution also concludes the stride-2 depth-wise 3×3 convolution at step 610.

Similarly to the regular (or stride-1) depth-wise convolution, the stride-2 depth-wise convolution also has similar distribution properties; The input (and the output) images of the stride-2 convolution operation is distributed (or partitioned across the two-dimensional array of compute cores). The arithmetic operations of the stride-2 depth-wise convolution are distributed across the two-dimensional array of compute cores. The data exchange between the compute cores is also distributed across the two-dimensional array of compute cores. Finally, the data exchange between the compute cores in the array is overlapped in time (or happening concurrently or simultaneously) with the arithmetic operations of the stride-2 depth-wise convolution.

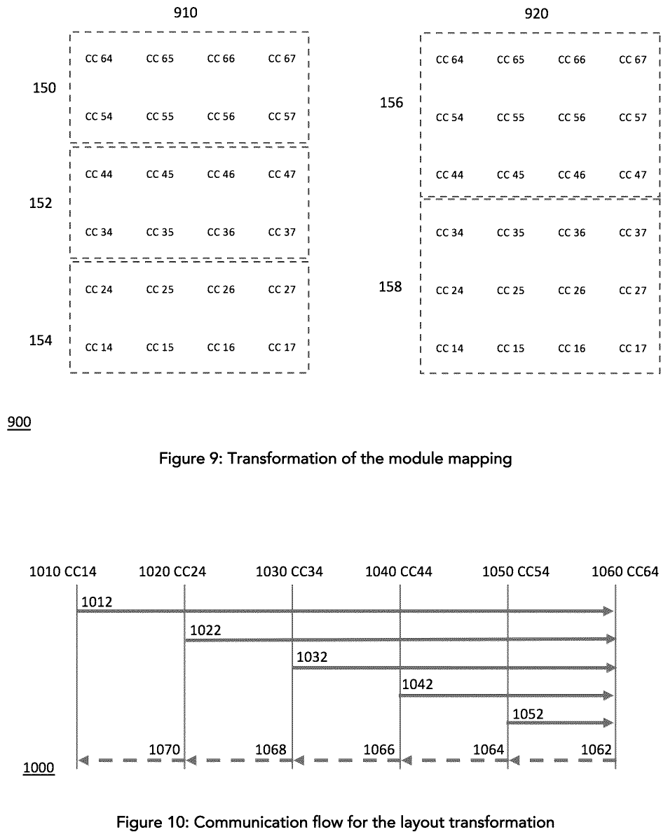

FIG. 9 illustrates one embodiment (or a possible example) of the mapping layout change. The left view of FIG. 9 shows the initial layout 910 and the right view of FIG. 9 is transformed (or resulting) layout 920. The layout 910 has three processing modules 150, 152 and 154 (same layout as in FIG. 1). Each of the processing modules 150,152 and 154 in the layout 910 occupies a rectangular sub-array of dimensions 2×4 compute cores. The layout 920 has 2 processing modules 156 and 158. Each of the processing modules 156 and 158 of layout 920 occupies a rectangular sub-array of dimensions 3×4 compute cores. While the total number of compute cores remained unchanged, the decrease (or reduction) in the processing module count (from 3 to 2) got compensated by the increased size of each processing module. In other words, processing modules 150, 152 and 154 occupy 8 compute cores each and the resulting processing modules 156 and 158 occupy 12 compute cores each.

FIG. 10 illustrates one embodiment (or a possible example) of the layout change implementation. In this embodiment, all columns of the two dimensional core array act (or function) independently of each other. For illustration purposes, FIG. 10 portrays just the first column of the core array (compute cores 1010 CC14, 1020 CC24, 1030 CC34, 1040 1050 CC44, 1060 CC64). All other columns of the two dimensional array perform the exact same operation as the column illustrated in FIG. 10. The layout change process uses two independent channels of information flow. In this particular example, the first communication channel facilitates data flowfrom top toward the bottom (a solid line in FIG. 10), the second communication channel facilitates data flow from bottom toward the top. These two channels can operate independently of (or concurrently to or in parallel) each other. For illustration purposes, the example in FIG. 10 presents the layout change steps in a sequential order.

The layout change process starts with each compute core storing a subimage of dimension Δw₁ (subimage width)×Δh₁ (subimage height)×Δc₁ (subimage channels), the compute cores collectively storing the whole image. The subimage could be a result of a load command 172 or could be a result of a previous operation, e.g. a convolution.

At first, the compute cores (1010 and 1020) running the topmost processing module 150 send (at steps 1012 and 1022 respectively) the hosted subimage on channel 1 (c=1) to the bottommost compute core 1060. The compute cores 1010 and 1020 repeat the steps 1012 and 1022 for the remaining channels: channel 2 (c=2), . . . , the last channel (c=Δc₁).

Next, the compute cores 1030 and 1040 running the second processing module 152 send (at steps 1032 and 1042 respectively) the hosted subimage on the first channel (c=1) to the bottommost compute core 1060. The compute cores 1030 and 1040 repeat the steps 1032 and 1042 for the remaining channels: channel 2 (c=2), . . . , the last channel (c=Δc₁).

Finally, the compute core 1050 running the third processing module 154 sends (at steps 1052) the hosted subimage on channel c=1 to the bottommost compute core 1060. The compute cores 1050 repeats step 1052 for the remaining channels: channel 2 (c=2), . . . , the last channel (c=Δc₁). Unlike the core 1050 (and all other cores in this example), the compute core 1060 does not send the data, since the core already hosts the subimage.

At steps 1062-1070, the bottommost compute core 1060 broadcasts the received subimages to all the compute cores 1010-1050 in the same order the core 1060 received them from cores 1010-1050. In one embodiment, each of the compute cores 1010-1050 accepts just the relevant portion of the image data sent by the core 1060. Since the target layout consists of two processing modules, instead of three, a subimage hosted on every compute core 1010-1060 is of dimensions Δw₂ (subimage width)×Δh₂ (subimage height)×Δc₂ (subimage channels), different from Δw₁, Δh₁, Δc₁.

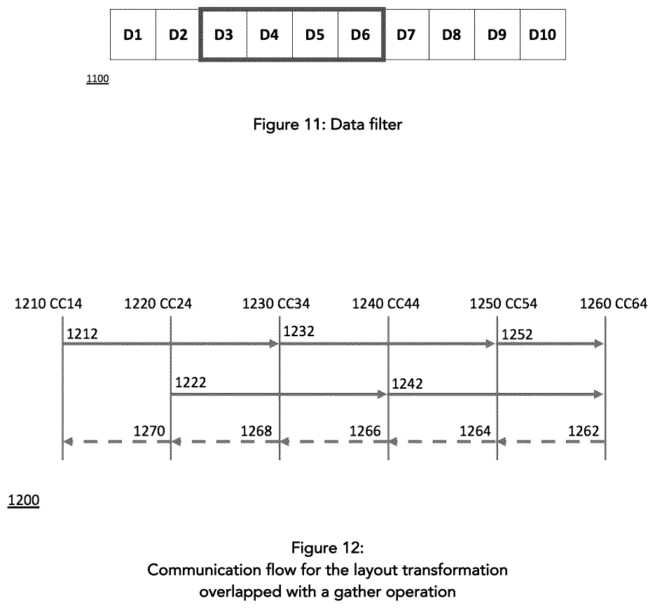

Each compute core selects the relevant portion of the data using a data filter (also referred to as a counter filter, or a window filter) 1100 shown in FIG. 11. The data filter has three parameters: total length N (N=10 in the example shown in FIG. 11), window length M (M=4 in the example shown in FIG. 11) and offset K (K=2 in the example shown in FIG. 11). The data filter 1100 ignores the first K data elements (D1, D2 in FIG. 11, since K=2), then accepts the following M data elements (D3, D4, D5, D6 in the example shown in FIG. 11, since M=4), and then ignores the rest N-M-K elements (D7, D8, D9, D10). After that, the data filter 1100 resets and starts over (by again ignoring the first K elements).

Each compute core 1010-1060 has two data filters, the first (pixel) data filter to select the relevant data on the width and height dimensions, the second (channel) data filter to select the relevant data on the channel dimension.

The pixel data filter is configured to have the total length of N=W×H (total pixel count of the image), the window length N=Δw₂×Δh₂ (the product of the width and height dimensions of subimage for the target layout). Each compute core 1010-1060 has its own offset for the pixel filter: Kᵢ=N*(i−1), where Kᵢ is the data filter offset for the compute core at row i and N is the window length of the pixel filter. In other words, core 1010 has an offset K=0, core 1020 has an offset K=N, core 1030 has an offset K=2N and so forth.

The channel filter is configured to have the total length of N=WXHXC (the total element count of the image), the window length N=WXH×Δc₂ (the total element count for each processing module 156, 158 in the targe layout 920). Each compute core 1010-1060 has its own offset for the channel data filter: Kᵢ=N_{c}*(i−1), where Kᵢ is the data filter offset for the compute core at row i and N_{c} is the window length of the channel data filter. In other words, core 1010 has an offset K=0, core 1020 has an offset K=N_{c}, core 1030 has an offset K=2N_{c} and so forth.

An alternate embodiment of the layout transform operation is shown in FIG. 12, in which the transform operation is overlapped with a reduction operation. An example of a reduction operation is a partial sum reduction operation, a part of the distributed matrix multiplication, a neural network layertype. During this operation, one or more of the compute cores would sum (or add) the subimages stored in the memory. In the example shown in FIG. 12, compute cores 1210, 1230 and 1250 sum the subimages together (at steps 1212, 1232, 1252). Similarly, cores 1220, 1240 and 1260 sum the subimages together (at steps 1222, 1242). Similarly to the flow 1000, the resulting sum is sent to the bottommost core 1260 and broadcasted up to the cores 1210-1250 at steps 1262-1270. The two data filters (pixel and channel) are configured the same way they are configured in the flow 1000. In this example, the layer transformation operation is fully overlapped with a partial sum reduction operation, requiring no additional computation from the compute cores. In other words, the arithmetic operation of the sum reduction is overlapped in time (or happening concurrently or simultaneously) with the data exchange necessary for the layout change operation.

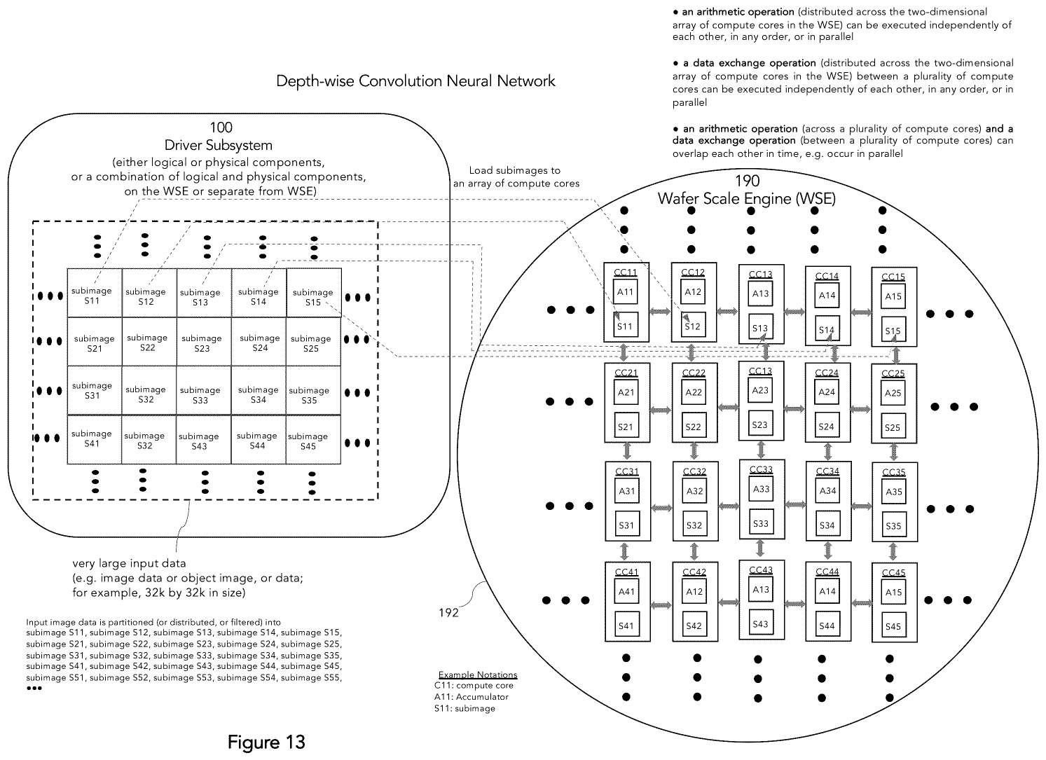

FIG. 13 is an overall diagram of the driving subsystem 100 for partitioning an image data (for example, possibly a very large image, such as 32 k by 32 k) for the neural network inference operations and distribution of a plurality of subimages across an array of compute cores in the wafer scale engine 190 with respect to FIGS. 1A and 1B by processing multiple layers with commands and weights. In this depth-wise separable convolution neural network, the combination of the driver subsystem 100 and the wafer scale engine 190, which the modules in the driver subsystem 100 can be implemented as physical modules or logical (or virtual) modules, as integrated or separate from the wafer scale engine 190, to provide a powerful computing platform on the single chip 192 (also referred to as the single wafer) that is capable to fast processing both a large image data (e.g., 32 k by 32 k image) and complex, high performance computing. This solution of the combination of the driver subsystem 100 and the wafer scale engine 190 overcomes both conventional bottlenecks in big data crunching and high-performance artificial intelligence parallel computing. To better understood the magnitude, as an example, Cerebras' current generation of wafer scale engine (also known as WSE-2) has 850,000 compute cores, on-chip memory of 40 gigabytes, memory bandwidth of 20 petabytes/second, and fabric bandwidth of 220 petabits/second, with a chip size of 46,225 m². For additional information on related technologies of wafer-scale integration with an array of processing elements, see, for example, U.S. Pat. No. 11,328,208, assigned to Cerebras Cerebras Systems Inc., the disclosure of which is incorporated herein by reference in its entirety.

The driver subsystem 100 receives a large image, such as an image data with the size of 32 k by 32 k that has about 1 billion pixels. To overcome potential big data bottleneck loading challenges, the driver subsystem 100 partitions (or distributes, or filters) the image data into subimages, illustrated partially, subimage S11, subimage S12 subimage S13, subimage S14, subimage S15 on the first row; subimage S21, subimage S22 subimage 23, subimage S24, subimage S25 on the second row; subimage S31, subimage S32, subimage S33, subimage S34, subimage S35 on the third row; and subimage S41, subimage S42 subimage S43, subimage S44, subimage S45 on the fourth row.

The wafer scale engine 190 loads (or preloads) the plurality of subimages into an array of compute cores. As shown in the wafer scale engine 190, the wafer scale engine 190 loads subimage S11 into a local memory on a compute core CC11 with an accumulator A11; subimage S12 into a local memory on a compute core CC12 with an accumulator A12; subimage S13 into a local memory on a compute core CC13 with an accumulator A13; subimage S14 into a local memory on a compute core CC14 with an accumulator A14; and subimage S15 into a local memory on a compute core CC15 with an accumulator A15.

The wafer scale engine 190 also loads (or preloads) subimage S21 into a local memory on a compute core CC21 with an accumulator A21; subimage S22 into a local memory on a compute core CC22 with an accumulator A22; subimage S23 into a local memory on a compute core CC23 with an accumulator A23; subimage S24 into a local memory on a compute core CC24 with an accumulator A24; and subimage S25 into a local memory on a compute core CC25 with an accumulator A25.

Moreover, the wafer scale engine 190 also loads (or preloads) subimage S31 into a local memory on a compute core CC31 with an accumulator A31; subimage S32 into a local memory on a compute core CC32 with an accumulator A32; subimage S33 into a local memory on a compute core CC33 with an accumulator A33; subimage S34 into a local memory on a compute core CC34 with an accumulator A34; and subimage S35 into a local memory on a compute core CC35 with an accumulator A35.

The wafer scale engine 190 further loads (or preloads) subimage S41 into a local memory on a compute core CC41 with an accumulator A41; subimage S42 into a local memory on a compute core CC42 with an accumulator A42; subimage S43 into a local memory on a compute core CC43 with an accumulator A43; subimage S44 into a local memory on a compute core CC44 with an accumulator A44; and subimage S45 into a local memory on a compute core CC45 with an accumulator A45.

In this embodiment, the plurality of subimages (or subimage data) are not only preloaded onto the respective compute cores in the array of compute cores, the plurality of subimages stay (or kept) resident on the respective compute cores over the duration of the depth-wise convolution operation. Each compute core has a local memory for storing data (for example, a portion of the image data, convolution filter weight) and an arithmetic logical unit (ALU), and one or more very high bandwidth connections with other compute cores. So long as the depth-wise convolution system maps and distributes a large image data in such a way as not to cause communication challenges between the plurality of compute cores, then the resulting performance of the depth-wise convolution system would meet the dual objectives in both data efficiency and computational efficiency. The depth-wise convolution system continues to work on the array of compute cores for processing the image data as the neural network is evaluated layer by layer.

When the wafer scale engine 190 executes an arithmetic operation as distributed across the two-dimensional array of compute cores, the wafer scale engine 190 executes the arithmetic operation across the two-dimensional array of compute cores such that: (1) each compute core executing independently of other compute cores, (2) the plurality of compute cores executing in any order, or (3) the plurality of compute cores executing in parallel relative to one another.

When the wafer scale engine 190 executes a data exchange operation as distributed across the two-dimensional array of compute cores, the wafer scale engine 190 executes the data exchange operation across the two-dimensional array of compute cores such that: (1) each compute core executing independently of other compute cores, (2) the plurality of compute cores executing in any order, or (3) the plurality of compute cores executing in parallel relative to one another.

When the wafer scale engine 190 executes an arithmetic operation across the plurality of compute cores and a data exchange operation between a plurality of compute cores, the wafer scale engine 190 executes the arithmetic operation across the plurality of compute cores that overlaps in time with the data exchange operation between the plurality of compute cores. For example, the waferscale engine 190 executes the arithmetic operation across the plurality of compute cores in parallel with the wafer scale engine 190 executing the data exchange operation between the plurality of compute cores.

A method, comprising (a) partitioning the input image to a plurality of subimages, each subimage having dimensions of Δw (subimage width)×Δh (subimage height)×Δc (subimage channel count), each subimage residing on the at least one compute core; (b) set a channel number for computing the following steps, comprising: (i) allocating a portion of a memory in the at least one compute core with the dimensions of (Δw+w_{f})×(Δh+h_{f}) to serve as an accumulator, where w_{f} and h_{f} are dimension of the extra space (frame) around the subimage; (ii) set the accumulator with an offset (i, j); (iii) receiving one or more weights by the plurality of compute cores; (iv) updating the accumulator by multiplying the input image by a weight Wᵢⱼ and adding the result to the accumulator with an offset of (i, j); (v) repeating steps (c)-(e) for all N×M (i,j) offset combinations: i ranging from 0 to N−1 and j ranging from 0 to M−1; (vi) sending, by at least one compute core, a portion of the accumulator to the one or more neighboring compute cores; and (vii) updating the accumulator of the at least one compute core with information received from the one or more neighboring compute cores, wherein the result of the above steps is in the accumulator; (c)copy the result to one or more memory locations; and (d) repeat steps (b), (c) for all channels.

A system, comprising (a) one or more weight modules configured for hosting and sending one or or more convolution weights; (b) one or more command modules configured for hosting and sending one or more commands; © one or more processing modules having a plurality of compute cores for computing: (i) one or more compute cores configured to receive convolution weights and/or configured to receive the one or commands; (ii) one or more compute cores configured to receive an image; (iii) the plurality of compute cores collectively storing an image, each compute core storing a portion of the image; (iv) providing a communication between a compute core (X) and immediate neighboring compute cores (X+1) surrounding the referenced compute core, or and a communication between the referenced compute core and not-immediate neighboring compute cores (X+N, N greater than 1); and (v) providing a linear chain connectivity between the plurality of compute cores; (d) one or more broadcast modules for broadcasting weights and commands to a first subset of the plurality of compute cores; and (e) one or more distribution modules for distributing weights and commands to a second subset of the plurality of compute cores.

A method for computing N×M depthwise strided convolution on a two-dimensional array of compute cores, comprising: (a) partitioning the input image of dimensions width×height×channel (w×h×c) to a plurality of partitioned subimages, each partitioned subimage having a dimensions of Δw₁ (subimage width)×Δh, (subimage height)×Δc₁ (subimage channels), each subimage residing on the at least one compute core; (b) applying a first predetermined permutation transformation to a first partitioned subimage (in the plurality of partitioned subimages) having dimensions Δw×Δh×Δc thereby resulting in a second subimage having dimensions Δw₂×Δh₂×Δc₂, where the second subimage having a size that is the same as the size of the first partitioned subimage, the size defined as a product of dimensions, Δw₁·Δh₁·Δc₁; (c) applying a second predetermined permutation transformation to the weights of each convolution filter having dimensions N₁×M₁ to produce a k sub-filters having dimensions N₂×M₂; (d) setting a channel number for computing the following steps, comprising (i) allocating a portion of a memory in the at least one compute core with the dimensions of (Δw₂+w_{f})×(Δh₂+h_{f}) to serve as an accumulator, where w_{f} and h_{f} are dimension of the extra space (frame) around the subimage; (ii) setting the accumulator with an offset (i, j); (iii) receiving one or more weights by the plurality of compute cores; (iv) updating the accumulator by multiplying the input image by a weight Wᵢⱼ and adding the result to the accumulator with an offset of (i, j); and (v) repeating steps (c)-(e) for all N₂×M₂ (i,j) offset combinations: i ranging from 0 to N₂−1 and j ranging from 0 to M₂−1; and (vi) sending, by at least one compute core, a portion of the accumulator to the one or more neighboring compute cores; (vii) updating the accumulator of the at least one compute core with information received from the one or more neighboring compute cores; (viii) repeating steps (i)-(vii) k times for each sub-filter, wherein the result of the above steps is in the accumulator copying the result to one or more memory locations; and repeating steps (b), (c) for all channels.

An image-processing method for a no overhead layout change, comprising (a) partitioning the input image of dimensions width×height×channel (w×h×c) to a plurality of partitioned subimages, each partitioned subimage having a dimensions of Δw₁ (subimage width)×Δh, (subimage height)×Δc₁ (subimage channels), each subimage residing on the at least one compute core; (b) forming one or more bi-directional linear chains having the plurality of compute cores, each compute core in a linear chain communicatively coupled with a at most one previous logical neighbor compute core and at most one next logical neighbor compute core, the linear chain in each compute core having a forward channel for receiving data from the previous logical neighbor compute core and sending the data to the next logical neighbor compute core, the linear chain in each compute core having a backward channel for receiving data from the next logical neighbor compute core and sending the data to the previous logical neighbor compute core; (c)on the forward channel, one or more compute cores in a chain receiving a portion of the subimage from the previous logical neighbor compute core in the chain, adding to the portion of the subimage hosted in the memory of the associated compute core and sending the resulting portion of the subimage to the next logical neighbor compute core in the chain; (d) on the forward channel, the last compute core on the chain receiving the portion of the subimage and sending the portion of the subimage on the backward channel to the previous logical neighbor compute core; (e) on the backward channel, one or more compute cores in a chain, including: (i) forwarding the subimages from the next logical neighbor compute core to the previous logical neighbor; (ii) updating a count based on the number of subimage pixels forwarded; and (iii) receiving a portion of the subimage into memory if the count satisfies a predetermined condition.

A depth-wise convolution system, comprises a weight module (110) configured to store and send one or more weights of the neural network layers' (e.g. convolution filters) through one or more broadcast modules (130) and one or more distribute modules (140) to one or more processing modules (150); a command module (120) configured to stores and sends one or more commands (or instructions) that drive the execution of a neural network through one or more broadcast modules (130) and one or more distribute modules (140) to one or more processing modules (150); one or more broadcast modules (130) configured to receive the one or more commands (instructions) and one or more weights from the weight module (110) and the command module (120) and broadcast the common portion of command (instruction) and weights to one or more processing modules (150); and one or more distribute module (140) configured to receive the one or more weights and commands (instructions) from either the weight module (110) or the command modules (120) and 120) or from the one or more broadcast modules (140) and distributes the one or more weights and commands (instructions) to one or more processing modules (150) or individual compute cores of one or more processing modules (150).

A depth-wise convolution system comprises a compute core array comprises M rows and N columns with a total of M×N compute cores; a weight module (110) mapped to a first rectangular sub-array, the plurality of compute cores in the first rectangular region of the two-dimensional array of compute cores, collectively running the weight module (110); a command module (120) mapped to a second rectangular sub-array, the plurality of compute cores in the second rectangular region of the two-dimensional array of compute cores, collectively running the command module (120); one or more broadcast modules (130) mapped to a third rectangular sub-array, the plurality of compute cores in the third rectangular region of the two-dimensional array of compute cores, collectively running the one or more broadcast modules (130); one or more distribute modules (140) mapped to fourth rectangular sub-array, the plurality of compute cores in the fourth rectangular region of the two-dimensional array of compute cores, collectively running one or more distribute modules (140); and one or more processing modules (150, 152, 154) mapped to a fifth rectangular sub-array, the plurality of compute cores in the fifth rectangular region of the two-dimensional array of compute cores, collectively running one or more distribute modules (150, 152, 154).

A depth-wise convolution method comprises partitioning an image data to a plurality of subimages, each subimage having predetermined dimensions of Δw (subimage width)×Δh (subimage height); distributing the plurality of subimages to a waferscale engine, the wafer scale engine having an array of compute cores, wherein the distribution step distributes the plurality of subimages to corresponding compute cores in the array of compute cores, each subimage residing on a corresponding compute core during a depth-wise convolution operation; and executing the depth-wise convolution operation in a distributed fashion and in parallel, the distributed fashion including (a) distributing the plurality of subimages into the array of compute cores, (b) distribute arithmetic of the depth-wise convolution operation into the array of compute cores, the parallel processing including (a) one or more data exchanges between the compute cores, and (b) the data exchange and arithmetic occur in parallel (or overlap time, or simultaneously, or concurrently).

A depth-wise stride-2 convolution method comprises partitioning an image data to a plurality of subimages, each subimage having predetermined dimensions of Δw (subimage width)×Δh (subimage height); distributing the plurality of subimages to a wafer scale engine, the wafer scale engine having an array of compute cores, wherein the distribution step distributes the plurality of subimages to corresponding compute cores in the array of compute cores, each subimage residing on a corresponding compute core during a depth-wise convolution operation; and executing the stride-2 depth-wise convolution operation in a distributed fashion and in parallel, the distributed fashion including (a) distributing the plurality of subimages into the array of compute cores, (b) distribute arithmetic of the stride-2 depth-wise convolution operation into the array of compute cores, the parallel processing including (a) one or more data exchanges between the compute cores, and (b) the data exchange and arithmetic occur in parallel (or overlap time, or simultaneously, or concurrently).

A depth-wise convolution method, comprises partitioning a sizable image data to a plurality of subimages, each subimage having predetermined dimensions of Δw (subimage width)×Δh (subimage height); distributing the plurality of subimages to a wafer scale engine, the wafer scale engine having an array of compute cores, wherein the distribution step distributes the plurality of subimages to corresponding compute cores in the array of compute cores, each subimage residing on a corresponding compute core during a depth-wise convolution operation; and executing the depth-wise convolution operation by the wafer scale engine on the array of compute cores in a distributed fashion, the distributed fashion including: (a) distributing the plurality of subimages into the array of compute cores, and (b) distribute arithmetic of the depth-wise convolution operation into the array of compute cores.

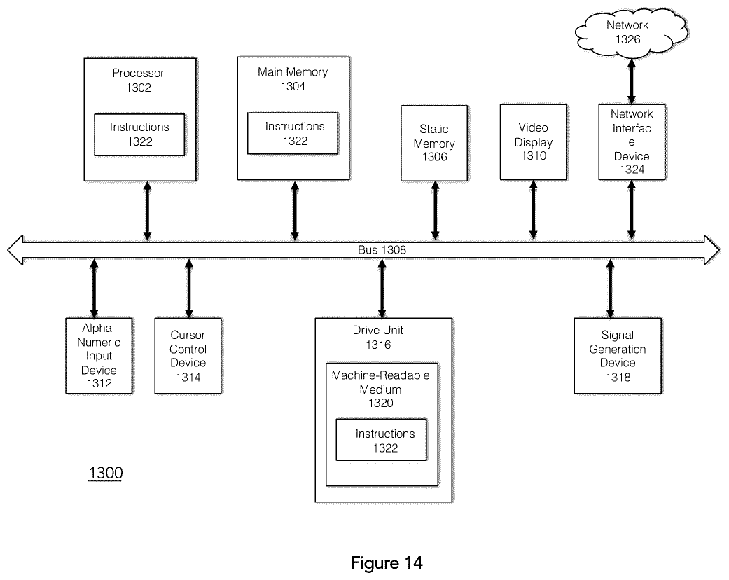

FIG. 14 illustrates an exemplary form of a computer system 1100, in which a set of instructions can be executed to cause the computer system to perform any one or more of the methodologies discussed herein. The computer devices 1300 may represent any or all of the clients, servers, or network intermediary devices discussed herein. Further, while only a single machine is illustrated, the term “machine” shall also be taken to include any collection of machines that individually or jointly execute a set (or multiple sets) of instructions to perform any one or more of the methodologies discussed herein. The exemplary computer system 1300 includes a processor 1302 (e.g., a central processing unit (CPU), a graphics processing unit (GPU), or both), a main memory 1304 and a static memory 1306, which communicate with each other via a bus 1308. The computer system 1300 may further include a video display unit 1310 (e.g. a liquid crystal display (LCD)). The computer system 1300 also includes an alphanumeric input device 1312 (e.g., a keyboard), a cursor control device 1314 (e.g., a mouse), a disk drive unit 1316, a signal generation device 1318 (e.g., a speaker), and a network interface device 1324.

The disk drive unit 1316 includes a machine-readable medium 1320 on which is stored one or more sets of instructions (e.g., software 1322) embodying anyone or more of the methodologies or functions described herein. The software 1322 may also reside, completely or at least partially, within the main memory 1304 and/or within the processor 1302. During execution the computer system 1300, the main memory 1304, and the instruction-storing portions of processor 1302 also constitute machine-readable media. The software 1322 may further be transmitted or received over a network 1326 via the network interface device 1324.

While the machine-readable medium 1320 is shown in an exemplary embodiment to be a single medium, the term “machine-readable medium” should be taken to include a single medium or multiple media (e.g. a centralized or distributed database, and/or associated caches and servers) that store the one or more sets of instructions. The term “machine-readable medium” shall also be taken to include any tangible medium that is capable of storing a set of instructions for execution by the machine and that cause the machine to perform anyone or more of the methodologies of the present invention. The term “machine-readable medium” shall accordingly be taken to include, but not be limited to, solid-state memories, and optical and magnetic media.

Some portions of the detailed descriptions herein are presented in terms of algorithms and symbolic representations of operations on data within a computer memory or other storage device. These algorithmic descriptions and representations are the means used by those skilled in the data processing arts to most effectively convey the substance of their work to others skilled in the art. An algorithm is here, and generally, conceived to be a self-consistent sequence of processing blocks leading to a desired result. The processing blocks are those requiring physical manipulations of physical quantities. Throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including cloud computing, flash memories, optical disks, magnetic-optical disks, read-only memories (ROMs), random access memories (RAMs), erasable programmable ROMs (EPROMs), electrically erasable and programmable ROMs (EEPROMs), magnetic or optical cards, application specific integrated circuits (ASICs), or any type of media suitable for storing electronic instructions, and each coupled to a computer system bus. Furthermore, the computers and/or other electronic devices referred to in the specification may include a single processor or may be architectures employing multiple processor designs for increased computing capability for artificial intelligence, machine learning, and big data high performance computing.

Moreover, terms such as “request”, “client request”, “requested object”, or “object” may be used interchangeably to mean action(s), object(s), and/or information requested by a client from a network device, such as an intermediary or a server. In addition, the terms “response” or “server response” may be used interchangeably to mean corresponding action(s), object(s) and/or information returned from the network device. Furthermore, the terms “communication” and “client communication” may be used interchangeably to mean the overall process of a client making a request and the network device responding to the request.

In respect of any of the above system, device or apparatus aspects, there may further be provided method aspects comprising steps to carry out the functionality of the system. Additionally or alternatively, optional features may be found based on any one or more of the features described herein with respect to other aspects.

The present disclosure has been described in particular detail with respect to possible embodiments. Those skilled in the art will appreciate that the disclosure may be practiced in other embodiments. The particular naming of the components, capitalization of terms, the attributes, data structures, or any other programming or structural aspect is not mandatory or significant, and the mechanisms that implement the disclosure or its features may have different names, formats, or protocols. The system may be implemented via a combination of hardware and software, as described, or entirely in hardware elements, or entirely in software elements. The particular division of functionality between the various system components described herein is merely examplary and not mandatory; functions performed by a single system component may instead be performed by multiple components, and functions performed by multiple components may instead be performed by a single component.

In various embodiments, the present disclosure can be implemented as a system or a method for performing the above-described techniques, either singly or in any combination. The combination of any specific features described herein is also provided, even if that combination is not explicitly described. In another embodiment, the present disclosure can be implemented as a computer program product comprising a computer-readable storage medium and computer program code, encoded on the medium, for causing a processor in a computing device or other electronic device to perform the above-described techniques.

As used herein, any reference to “one embodiment” or to “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment.

It should be borne in mind, however, that all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing” or “computing” or “calculating” or “displaying” or “determining” or the like refer to the action and processes of a computer system, or similar electronic computing module and/or device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, and/or hardware, and, when embodied in software, it can be downloaded to reside on, and operated from, different platforms used by a variety of operating systems.

The algorithms and displays presented herein are not inherently related to any particular computer, virtualized system, or other apparatus. Various general-purpose systems may also be used with programs, in accordance with the teachings herein, or the systems may prove convenient to construct more specialized apparatus needed to perform the required method steps. The required structure for a variety of these systems will be apparent from the description provided herein. In addition, the present disclosure is not described with reference to any particular programming language. It will be appreciated that a variety of programming languages may be used to implement the teachings of the present disclosure as described herein, and any references above to specific languages are provided for disclosure of enablement and best mode of the present disclosure.

In various embodiments, the present disclosure can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the disclosure include a mobile phone, personal digital assistant, smartphone, digital watch, kiosk, desktop computer, laptop computer, tablet, consumer electronic device, television, set-top box, or the like. An electronic device for implementing the present disclosure may use an operating system such as, for example, iOS available from Apple Inc. of Cupertino, Calif., Android available from Google Inc. of Mountain View, Calif., Microsoft Windows 11, Windows 11 Enterprise, Windows Server 2022 available from Microsoft Corporation of Redmond, Wash., or any other operating system that is adapted for use on the device. In some embodiments, the electronic device for implementing the present disclosure includes functionality for communication over one or more networks, including for example a cellular telephone network, wireless network, and/or computer network such as the Internet.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” orany othervariation thereof are intended to covera non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one as or more than one. The term “plurality,” as used herein, is defined as two or as more than two. The term “another,” as used herein, is defined as at least a second or more.

An ordinary artisan should require no additional explanation in developing the methods and systems described herein but may find some possibly helpful guidance in the preparation of these methods and systems by examining standardized reference works in the relevant art.

While the disclosure has been described with respect to a limited number of embodiments, those skilled in the art, having benefit of the above description, will appreciate that other embodiments may be devised which do not depart from the scope of the present disclosure as described herein. It should be noted that the language used in the specification has been principally selected for readability and instructional purposes, and may not have been selected to delineate or circumscribe the inventive subject matter. The terms used should not be construed to limit the disclosure to the specific embodiments disclosed in the specification and the claims, but the terms should be construed to include all methods and systems that operate under the claims set forth herein below. Accordingly, the disclosure is not limited by the disclosure, but instead its scope is to be determined entirely by the following claims.

What is claimed is:

1. A method for M×N single channel depth-wise convolution, on a two-dimensional array of compute cores, comprising:
(a) partitioning the input image to a plurality of subimages, each subimage having dimensions of Δw (subimage width)×Δh (subimage height), each subimage residing on the at least one compute core;
(b) allocating a portion of a memory in the at least one compute core with the dimensions of (Δw+w_{f})×(Δh+h_{f}) to serve as an accumulator, where w_{f} and h_{f} are dimension of the extra space (frame) around the subimage;
(c) set the accumulator with an offset (i, j);
(d) receiving one or more weights by the plurality of compute cores;
(e) updating the accumulator by multiplying the input image by a weight Wᵢⱼ and adding the result to the accumulator with an offset of (i, j);
(f) repeating steps (c)-(e) for all N×M (i,j) offset combinations: i ranging from 0 to N−1 and j ranging from 0 to M−1;
(g) sending, by at least one compute core, a portion of the accumulator to the one or more neighboring compute cores; and
(h) updating the accumulator of the at least one compute core with information received from the one or more neighboring compute cores;
wherein the result of the above steps is in the accumulator.

2. The method of claim 2, wherein the one or more neighboring compute cores are immediately adjacent to the at least one compute core, the one or more neighboring compute cores having an immediately left-adjacent neighboring compute core, an immediately right-adjacent neighboring compute core, an immediately top-adjacent neighboring compute core, an immediately bottom-adjacent neighboring compute core, relative to the at least one compute core, the at least one compute core and the one or more neighboring compute cores formed an array.

3. The method of claim 1, wherein the one or more neighboring compute cores are adjacent with an integer offset relative to the at least one compute core, the one or more neighboring compute cores having a left-adjacent neighboring compute core, a right-adjacent neighboring compute core, a top-adjacent neighboring compute core, a bottom-adjacent neighboring compute core, relative to the at least one compute core, the integer offset being a number ranging from 1, 2, 3, 4, 5 . . . N.

4. The method of claim 1, wherein the plurality of compute cores receive one or more weights from a computer server, another compute core, another computing device.

5. The method of claim 1, wherein the plurality of compute cores set the accumulator with an offset (i, j) in response to receiving a command from a computer server, another compute core, or another computing device.

6. The method of claim 1, prior to the partitioning step, further comprises receiving, by at least one compute core in a plurality of compute cores, information from a computer server, the plurality of compute cores arranged in a two dimensional (2D) array on a semiconductor engine, the at least one compute core capable to communicate with one or more surrounding neighboring compute cores, the information including an input image having a width (w), a height (h), a channel (c), represented as w×h×c.

7. The method of claim 1, wherein the steps (g) and (h) comprises a horizontal 3×3 frame exchange, the horizontal 3×3 exchange including:
(a) sending the full first column of the accumulator to the one of the immediately horizontally neighboring cores
(b) sending the full last column of the accumulator to the other immediately horizontally neighboring cores
(c) receiving a full column from one of the immediately horizontally neighboring core and add its contents to the contents of the second column of the accumulator
(d) receive a full column from the other immediately horizontally neighboring core and add its contents to the contents of the last but one column of the accumulator

8. The method of claim 7, wherein the one of the immediately horizontally neighboring cores comprises either an immediately horizontally left neighboring core or an immediately horizontally right neighboring core.

9. The method of claim 7, wherein if the left neighboring core is used in steps (a) and (c), then the right neighboring core is used in steps (b) and (d).

10. The method of claim 7, wherein if the right neighboring core is used in steps (a) and (c), then the left neighboring core is used in steps (b) and (d).

11. The method of claim 1, wherein the steps (g) and (h) comprises a vertical 3×3 frame exchange, comprises:
(a) sending the first row of the accumulator to the one of the immediately vertically neighboring core;
(b) sending the last row of the accumulator to the other vertically horizontally neighboring core;
(c) receiving a full row from one of the immediately vertically neighboring core and add its contents to the contents of the second row of the accumulator; and
(d) receiving a full row from the other immediately vertically neighboring core and add its contents to the contents of the last but one row of the accumulator.

12. The method of claim 11, wherein the one of the immediately vertically neighboring cores comprises either an immediately vertically top neighboring core or an immediately vertically bottom neighboring core.

13. The method of claim 11, wherein if the vertically top neighboring core is used in steps (a) and (c), then the vertically bottom neighboring core is used in steps (b) and (d).

14. The method of claim 11, wherein if the bottom neighboring core is used in steps (a) and (c), then the top neighboring core is used in steps (b) and (d).

15. The method of claim 1, wherein the steps (g) and (h) comprises a full 3×3 frame exchange for
(a) sending the first column of the accumulator to the one of the immediately horizontally neighboring core;
(b) sending the last column of the accumulator to the other immediately horizontally neighboring core;
(c) receiving a full column from one of the immediately horizontally neighboring core and add its contents to the contents of the second column of the accumulator;
(d) receiving a full column from the other immediately horizontally neighboring core and add its contents to the contents of the last but one column of the accumulator (e) sending the first accumulator truncated row to the one of the immediately vertically neighboring core;
(f) sending the last accumulator truncated row to the other vertically horizontally neighboring core;
(g) receiving a truncated row from one of the immediately vertically neighboring core and add its contents to the contents of the second row of the accumulator starting with an offset; and
(h) receiving a truncated row from the other immediately vertically neighboring core and add its contents to the contents of the last but one row of the accumulator, starting with an offset.

16. The method of claim 15, wherein the truncated row comprises a row without a first element and a last element.

17. The method of claim 15, wherein the offset comprises the second row element.

18. The method of claim 15, wherein the one of the immediately horizontally neighboring cores comprises either an immediately horizontally left neighboring core or an immediately horizontally right neighboring core.

19. The method of claim 15, wherein the one of the immediately vertically neighboring cores comprises either an immediately vertically top neighboring core or an immediately vertically bottom neighboring core.

20. The method of claim 15, wherein if the left neighboring core is used in steps (a) and (c), then the right neighboring core is used in steps (b) and (d).

21. The method of claim 15, wherein if the right neighboring core is used in steps (a) and (c), then the left neighboring core is used in steps (b) and (d).

22. The method of claim 15, wherein if the top neighboring core is used in steps (e) and (g), then the bottom neighboring core is used in steps (f) and (h).

23. The method of claim 15, wherein if the bottom neighboring core is used in steps (e) and (g), then the top neighboring core is used in steps (f) and (h).

24. The method of claim 1, wherein the array of the compute cores comprises one or more of compute cores in, the one or more compute cores having one or more memory buffers, a compute core having a memory buffer for storing a subimage of the input image and for storing the accumulator that includes the frame, and exchanging the frame with the one or more neighboring compute cores.

25. The method of claim 1, wherein the steps (e), (f), (g) comprise the processing of the following equation:
A_{x+i y+j}=A_{x+i y+j}+S_{xy}*Wᵢⱼ, wherein
the symbol A represents accumulator,
symbol S represents the subimage,
first subscript (i or x+i or x) represents a row number of the accumulator,
second subscript (j or y+j or y) represents a column number of the accumulator, and
the symbol Wᵢⱼ represents the (i,j) weight of the convolution filter.

26. The method of claim 25, wherein the equation comprises computing the followings:
$$\begin{matrix}{A}_{x + 0 y + 0} = {A}_{x + 0 y + 0} + {S}_{x y} * {w}_{00} \\ {A}_{x + 1 y + 0} = {A}_{x + 1 y + 0} + {S}_{x y} * {w}_{10} \\ {A}_{x + 2 y + 0} = {A}_{x + 2 y + 0} + {S}_{x y} * {w}_{20} \\ {A}_{x + 0 y + 1} = {A}_{x + 0 y + 1} + {S}_{x y} * {w}_{01} \\ {A}_{x + 1 y + 1} = {A}_{x + 1 y + 1} + {S}_{x y} * {w}_{11} \\ {A}_{x + 2 y + 1} = {A}_{x + 2 y + 1} + {S}_{x y} * {w}_{21} \\ {A}_{x + 0 y + 2} = {A}_{x + 0 y + 2} + {S}_{x y} * {w}_{02} \\ {A}_{x + 1 y + 2} = {A}_{x + 1 y + 2} + {S}_{x y} * {w}_{12} \\ {A}_{x + 2 y + 2} = {A}_{x + 2 y + 2} + {S}_{x y} * {w}_{22}\end{matrix}$$

27. The method of claim 1, wherein the N×M matrix combinations comprise 3×3 convolution filters.

28. The method of claim 1, wherein the dimensions of (Δw+w_{f})×(Δh+h_{f}) comprise (Δw+2)×(Δh+2).

29. The method of claim 1, wherein method implements a depth-wise convolution as a part of a neural network.

30. A method for M×N multi-channel depth-wise convolution, on a two-dimensional array of compute cores, comprising:
(a) partitioning the input image to a plurality of subimages, each subimage having dimensions of Δw (subimage width)×Δh (subimage height)×Δc (subimage channel count), each subimage residing on the at least one compute core;
(b) set a channel number for computing the following steps, comprising:
(i) allocating a portion of a memory in the at least one compute core with the dimensions of (Δw+w_{f})×(Δh+h_{f}) to serve as an accumulator, where w_{f} and h_{f} are dimension of the extra space (frame) around the subimage;
(ii) set the accumulator with an offset (i, j);
(iii) receiving one or more weights by the plurality of compute cores;
(iv) updating the accumulator by multiplying the input image by a weight Wᵢⱼ and
adding the result to the accumulator with an offset of (i, j);
(v) repeating steps (c)-(e) for all N×M (i,j) offset combinations: i ranging from 0 to N−1 and j ranging from 0 to M−1; and
(vi) sending, by at least one compute core, a portion of the accumulator to the one or more neighboring compute cores;
(vii) updating the accumulator of the at least one compute core with information received from the one or more neighboring compute cores.
wherein the result of the above steps is in the accumulator
(c) copy the result to one or more memory locations; and
(d) repeat steps (b), (c) for all channels.

31. The method of claim 30, wherein method implements a depth-wise convolution as a part of a neural network.

32. A system, comprising:
(a) one or more weight modules configured for hosting and sending one or or more convolution weights;
(b) one or more command modules configured for hosting and sending one or more commands;
(c) one or more processing modules having a plurality of compute cores for computing:
(i) one or more compute cores configured to receive convolution weights and/or configured to receive the one or commands;
(ii) one or more compute cores configured to receive an image
(iii) the plurality of compute cores collectively storing an image, each compute core storing a portion of the image;
(iv) providing a communication between a compute core (X) and immediate neighboring compute cores (X+1) surrounding the referenced compute core, or and a communication between the referenced compute core and not-immediate neighboring compute cores (X+N, N greater than 1); and
(v) providing a linear chain connectivity between the plurality of compute cores;
(d) one or more broadcast modules for broadcasting weights and commands to a first subset of the plurality of compute cores; and
(e) one or more distribution modules for distributing weights and commands to a second subset of the plurality of compute cores.

33. The system of claim 32, where the one or more weight modules reside on a subset of the plurality of cores.

34. The system of claim 32, where the one or more weight modules reside on a computer server coupled to the plurality of compute cores.

35. The system of claim 32, where the one or more command modules reside on a subset of the plurality of cores.

36. The system of claim 32, where the one or more command modules reside on a computer server coupled to the plurality of compute cores.

37. The system of claim 32, where the image of dimensions having an image width w, an image height h, and an image channel count c, is stored by a plurality of rectangular arrays of compute cores, each compute core storing a subimage of dimensions having a subimage width Δw, a subimage height Δh, a subimage channel count Δc, each rectangular array of compute cores collectively storing a subimage of dimensions the image width, the image height, and the subimage channel count.

38. The system of claim 32, where a three-dimensional image is stored by a plurality of rectangular arrays of compute cores, each compute core storing a portion of the three-dimensional image, each rectangular array of compute cores collectively storing a two-dimensional slice of the three-dimensional image, where the two-dimensional slice of the three-dimensional image comprises a full two-dimensional extent of the three-dimensional image and a portion of the three-dimensional image on the third dimension of the three-dimensional image.

39. The system of claim 32, further comprising eight independent communication routing channels: four channels to send data from the referenced compute core to the top, bottom, left and right immediate neighboring compute cores, and four channels to receive the data from the top, bottom, left and right immediate neighboring compute cores from the referenced compute core.

40. The system of claim 32, where the linear communication chain comprises a column of compute cores and two channels having a forward channel and a backward channel,
on the forward channel, at least one compute core in the column sending information to an immediate bottom neighboring compute core and receiving information from an immediate top neighboring compute core; and
on the backward channel, at least one compute core in the column sending information to an immediate top neighboring compute core and receiving information from an immediate bottom neighboring compute core.

41. The system of claim 32, where the linear communication chain comprises a row of compute cores and two channels having a forward channel and a backward channel,
on the forward channel, at least one compute core in the column sending information to an immediate right neighboring compute core and receiving information from an immediate left neighboring compute core; and
on the backward channel, at least one compute core in the column sending information to an immediate left neighboring compute core and receiving information from an immediate right neighboring compute core.

42. The system of claim 32, where the one or more broadcast modules having a broadcast module that comprises a rectangular array of compute cores including an input compute core receiving information and one or more output compute cores sending out the information that the input core received.

43. The system of claim 32, where the one or more distribution modules having a distribution module that comprises a rectangular array of compute cores, including an input compute core receiving information and one or more compute cores sending out portions of the information that the input core received.

44. A method for computing N×M depth-wise strided convolution on a two-dimensional array having one or more compute cores, comprising:
(a) partitioning the input image of dimensions width×height×channel (w×h×c) to a plurality of partitioned subimages, each partitioned subimage having a dimensions of Δw₁ (subimage width)×Δh, (subimage height)×Δc₁ (subimage channels), each subimage residing on the at least one compute core;
(b) applying a first predetermined permutation transformation to a first partitioned subimage (in the plurality of partitioned subimages) having dimensions Δw×Δh×Δc thereby resulting in a second subimage having dimensions Δw₂×Δh₂×Δc₂, where the second subimage having a size that is the same as the size of the first partitioned subimage, the size defined as a product of dimensions, Δw₁·Δh₁·Δc₁;
(c) applying a second predetermined permutation transformation to the weights of each convolution filter having dimensions N₁×M₁ to produce a k sub-filters having dimensions N₂×M₂;
(d) setting a channel number for computing the following steps, comprising:
(i) allocating a portion of a memory in the at least one compute core with the dimensions of (Δw₂+w_{f})×(Δh₂+h_{f}) to serve as an accumulator, where w_{f} and h_{f} are dimension of the extra space (frame) around the subimage;
(ii) setting the accumulator with an offset (i, j);
(iii) receiving one or more weights by the plurality of compute cores;
(iv) updating the accumulator by multiplying the input image by a weight Wᵢⱼ and adding the result to the accumulator with an offset of (i, j);
(v) repeating steps (c)-(e) for all N₂×M₂ (i,j) offset combinations: i ranging from 0 to N₂−1 and j ranging from 0 to M₂−1;
(vi) sending, by at least one compute core, a portion of the accumulator to the one or more neighboring compute cores;
(vii) updating the accumulator of the at least one compute core with information received from the one or more neighboring compute cores; and
(viii) repeating steps (i)-(vii) k times for each sub-filter;
wherein the result of the above steps is in the accumulator,
copying the result to one or more memory locations; and
repeating steps (b), (c) for all channels.

45. The method of claim 44, wherein the step (b) comprises a predetermined 3×3 stride 2 subimage permutation:
(a) allocating the memory for the output subimage of dimensions Δw₁/2 (output subimage width)×Δh₁/2 (output subimage height)×4Δc₁ (output subimage channels), the input subimage having dimensions Δw₁ (subimage width)×Δh₁ (subimage height)×Δc₁ (subimage channels);
(b) setting a channel number i for computing the following steps, comprising:
(c) copying a portion of the subimage comprising of all odd columns and all odd rows on the selected channel i into the channel 4×i of the allocated output subimage memory;
(d) copying a portion of the subimage comprising of all even columns and all odd rows on the selected channel i into the channel 4×i+1 of the allocated output subimage memory;
(e) copying a portion of the subimage comprising of all odd columns and all even rows on the selected channel i into the channel 4×i+2 of the allocated output subimage memory;
(f) copying a portion of the subimage comprising of all even columns and all even rows on the selected channel i into the channel 4×i+3 of the allocated output subimage memory;
(g) repeating steps (b)-(f) for all Δc₁ channels i in the input subimage; and
(h) repeating step (g) on one or more compute cores in the array.

46. The method of claim 44, wherein the step (c) comprises a 3×3 stride 2 filter permutation:
(a) transforming a 3×3 convolution having a plurality of filter weights [w₁, w₂, w₃, w₄, w₅, w₆, w₇, w₈, w₉] into 4 2×2 convolution filters:
(b) wherein a first 2×2 convolution filter weights are [w₁, w₃, w₇, w₉]
(c) wherein a second 2×2 convolution filter weights are [w₂, 0,w₈, 0]
(d) wherein a third 2×2 convolution filter weights are [w₄, w₆, 0, 0]
(e) wherein a fourth 2×2 convolution filter weights are [w₅, 0, 0, 0]
wherein the plurality of the filter weights comprises a first weight w₁, a second weight w₂, a third weight w₃, a fourth weight w₄, a fifth weigh tw₅, a sixth weight w₆, a seventh weight w₇, an eighth weight w₈, and a ninth weight w₉.

47. The method of claim 44, wherein the step (c) comprises a 3×3 stride 2 filter permutation: transforming a 3×3 convolution having a plurality of filter weights into a plurality of 2×2 convolution filters.

48. An image-processing method for a no overhead layout change, comprising:
(a) partitioning the input image of dimensions width×height×channel (w×h×c) to a plurality of partitioned subimages, each partitioned subimage having a dimensions of Δw₁ (subimage width)×Δh, (subimage height)×Δc₁ (subimage channels), each subimage residing on the at least one compute core;
(b) forming one or more bi-directional linear chains having the plurality of compute cores, each compute core in a linear chain communicatively coupled with a at most one previous logical neighbor compute core and at most one next logical neighbor compute core, the linear chain in each compute core having a forward channel for receiving data from the previous logical neighbor compute core and sending the data to the next logical neighbor compute core, the linear chain in each compute core having a backward channel for receiving data from the next logical neighbor compute core and sending the data to the previous logical neighbor compute core;
(c) on the forward channel, one or more compute cores in a chain receiving a portion of the subimage from the previous logical neighbor compute core in the chain, adding to the portion of the subimage hosted in the memory of the associated compute core and sending the resulting portion of the subimage to the next logical neighbor compute core in the chain;
(d) on the forward channel, the last compute core on the chain receiving the portion of the subimage and sending the portion of the subimage on the backward channel to the previous logical neighbor compute core; and
(e) on the backward channel, one or more compute cores in a chain, including:
(i) forwarding the subimages from the next logical neighbor compute core to the previous logical neighbor;
(ii) updating a count based on the number of subimage pixels forwarded; and
(iii) receiving a portion of the subimage into memory if the count satisfies a predetermined condition.

49. The method in claim 48, wherein the linear chain in step (b) comprises a column of compute cores in a two-dimensional array, a next logical neighbor compute core representing the top immediate neighbor compute core relative to the array and the previous logical neighbor compute core representing the bottom immediate neighbor compute core relative to the array.

50. The method in claim 48, wherein the linear chain in step (b) comprises a column of compute cores in a two-dimensional array, a next logical neighbor compute core representing the bottom immediate neighbor compute core relative to the array and the previous logical neighbor compute core representing the top immediate neighbor compute core relative to the array.

51. The method in claim 48, wherein the linear chain in step (b) comprises a row of compute cores in a two-dimensional array, a next logical neighbor compute core representing the left immediate neighbor compute core relative to the array and the previous logical neighbor compute core representing the right immediate neighbor compute core relative to the array.

52. The method in claim 48, wherein the linear chain in step (b) comprises a row of compute cores in a two-dimensional array, a next logical neighbor compute core representing the right immediate neighbor compute core relative to the array and the previous logical neighbor compute core representing the left immediate neighbor compute core relative to the array.

53. The method in claim 48, wherein the predetermined condition of the count comprises a windowed counter such that a condition is true if the count is greater than a first predetermined value (A) and less than a second predetermined value (B) and is reset to a third predetermined value (C) when the count reaches a fourth predetermined value (N).

54. The method in claim 48, wherein the predetermined condition of the count comprises a plurality of windowed counters such that a condition is true if the count is greater than all values in a first predetermined set of values (A1, A2, . . . ) and less than all value in a second predetermined set of values (B1, B2, . . . ) and is reset to a third predetermined value (C) when the count reaches a fourth predetermined value (N).

55. A depth-wise convolution system, comprising:
a weight module (110) configured to store and send one or more weights of the neural network layers through one or more broadcast modules (130) and one or more distribute modules (140) to one or more processing modules (150);
a command module (120) configured to store and send one or more commands that drive the execution of a neural network through one or more broadcast modules (130) and one or more distribute modules (140) to one or more processing modules (150);
one or more broadcast modules (130) configured to receive the one or more commands (instructions) and one or more weights from the weight module (110) and the command module (120) and broadcast the common portion of command (instruction) and weights to one or more processing modules (150); and
one or more distribute module (140) configured to receive the one or more weights and commands (instructions) from either the weight module (110) or the command modules (120) and 120) or from the one or more broadcast modules (140) and distributes the one or more weights and commands (instructions) to one or more processing modules (150) or individual compute cores of one or more processing modules (150).

56. A depth-wise convolution system, comprising:
a compute core array comprises M rows and N columns with a total of M×N compute cores;
a weight module (110) mapped to a first rectangular sub-array, the plurality of compute cores in the first rectangular region of the two-dimensional array of compute cores, collectively running the weight module (110);
a command module (120) mapped to a second rectangular sub-array, the plurality of compute cores in the second rectangular region of the two-dimensional array of compute cores, collectively running the command module (120);
one or more broadcast modules (130) mapped to a third rectangular sub-array, the plurality of compute cores in the third rectangular region of the two-dimensional array of compute cores, collectively running the one or more broadcast modules (130);
one or more distribute modules (140) mapped to fourth rectangular sub-array, the plurality of compute cores in the fourth rectangular region of the two-dimensional array of compute cores, collectively running one or more distribute modules (140); and
one or more processing modules (150, 152, 154) mapped to a fifth rectangular sub-array, the plurality of compute cores in the fifth rectangular region of the two-dimensional array of compute cores, collectively running one or more distribute modules (150, 152, 154).

57. A depth-wise convolution method, comprising:
partitioning, by a driving subsystem, an image data to a plurality of subimages, each subimage having predetermined dimensions of Δw (subimage width)×Δh (subimage height);
distributing, by the driving subsystem, the plurality of subimages to a wafer scale engine, the wafer scale engine having an array of compute cores, wherein the distribution step distributes the plurality of subimages to corresponding compute cores in the array of compute cores, each subimage residing on a corresponding compute core during a depth-wise convolution operation; and
executing, by the wafer scale engine, the depth-wise convolution operation in a distributed fashion and in parallel, the distributed fashion including (a) distributing the plurality of subimages into the array of compute cores, (b) distribute arithmetic of the depth-wise convolution operation into the array of compute cores, the parallel processing including (a) one or more data exchanges between the compute cores, and (b) the data exchange and arithmetic occur in parallel.

58. A depth-wise stride-2 convolution method, comprising:
partitioning an image data to a plurality of subimages, each subimage having predetermined dimensions of Δw (subimage width)×Δh (subimage height);
distributing the plurality of subimages to a wafer scale engine, the wafer scale engine having an array of compute cores, wherein the distribution step distributes the plurality of subimages to corresponding compute cores in the array of compute cores, each subimage residing on a corresponding compute core during a depth-wise convolution operation; and
executing the stride-2 depth-wise convolution operation in a distributed fashion and in parallel, the distributed fashion including (a) distributing the plurality of subimages into the array of compute cores, (b) distribute arithmetic of the stride-2 depth-wise convolution operation into the array of compute cores, the parallel processing including (a) one or more data exchanges between the compute cores, and (b) the data exchange and arithmetic occur in parallel.

59. A depth-wise convolution method, comprising:
partitioning a sizable image data to a plurality of subimages, each subimage having predetermined dimensions of Δw (subimage width)×Δh (subimage height);
distributing the plurality of subimages to a wafer scale engine, the wafer scale engine having an array of compute cores, wherein the distribution step distributes the plurality of subimages to corresponding compute cores in the array of compute cores, each subimage residing on a corresponding compute core during a depth-wise convolution operation; and
executing the depth-wise convolution operation by the wafer scale engine on the array of compute cores in a distributed fashion, the distributed fashion including: (a) distributing the plurality of subimages into the array of compute cores, and (b) distribute arithmetic of the depth-wise convolution operation into the array of compute cores.

60. The method of claim 59, wherein the wafer scale engine executes the arithmetic operation as distributed across the two-dimensional array of compute cores, the wafer scale engine executing the arithmetic operation across the two-dimensional array of compute cores such that: (a) each compute core executing independently of other compute cores, (b) the plurality of compute cores executing in any order, or (c) the plurality of compute cores executing in parallel relative to one another.

61. The method of claim 59, wherein the wafer scale engine executes the data exchange operation as distributed across the two-dimensional array of compute cores, the wafer scale engine executing the data exchange operation across the two-dimensional array of compute cores such that: (a) each compute core executing independently of other compute cores, (b) the plurality of compute cores executing in any order, or (c) the plurality of compute cores executing in parallel relative to one another.

62. The method of claim 59, wherein the wafer scale engine executes the arithmetic operation across the two-dimensional array of compute cores and the data exchange operation between the plurality of compute cores, the wafer scale engine executing the arithmetic operation across the plurality of compute cores that overlaps in time with the data exchange operation between the plurality of compute cores.

63. The method of claim 59, wherein the wafer scale engine executes the arithmetic operation across the two-dimensional array of compute cores and the data exchange operation between the plurality of compute cores, the wafer scale engine executing the arithmetic operation across the plurality of compute cores in parallel with the data exchange operation between the plurality of compute cores.
